(19) United States
(12) Patent Application Publication
(10) Pub. No.: US 2017/0291982 A1
(43) Pub. Date: Oct. 12, 2017

(54) A SELF-HEALING, REPROCESSABLE AND RECYCLABLE CROSSLINKED POLYMER AND PROCESS FOR ITS PREPARATION

(71) Applicant: FUNDACIÓN CIDETEC, Donostia-San Sebatián (ES)

(72) Inventors: Ibon ODRIOZOLA, Donostia-San Sebastián (ES); Alaitz RUIZ DE LUZURIAGA, Donostia-San Sebastián (ES); Alaitz REKONDO, Donostia-San Sebastián (ES); Roberto MARTÍN, Donostia-San Sebastián (ES); Germán CABAÑERO, Donostia-San Sebastián (ES); Hans-Jürgen GRANDE, Donostia-San Sebastián (ES)

(21) Appl. No.: 15/509,151

(22) PCT Filed: Sep. 21, 2015
(86) PCT No.: PCT/EP2015/071612

§ 371 Date: Mar. 6, 2017

(30) Foreign Application Priority Data
Sep. 22, 2014 (EP) 14382355.7

(51) Int. Cl. C08G 18/32; C08J 11/12; C08G 18/65; C08G 18/75; C08G 18/48; C08G 18/10; C08G 18/24

(52) U.S. Cl. CPC C08G 18/3243; C08G 18/10; C08J 11/12; C08G 18/246; C08G 18/758; C08G 18/4829; C08G 18/4825; C08G 18/6529; C08J 2375/12

(57) ABSTRACT

The polymer comprises units of formula (I) and of formula (Ibis), being comprised the molar ratio between units (I) and (Ibis) comprised from 1.0:0.2 to 1.0:0.8, and wherein R₄ are independently selected from radicals of formula (II), (III), and (IV), R₁ and R₁′ are independently selected from: —H, (C₁-C₂₀)alkyl, (C₅-C₁₄)aryl, —OR₅, —(CO)R₆, —O(CO)R₇, —(SO)R₈, —NH—CO—R₉, —COOR₁₀, —NR₁₁R₁₂, —NO₂, and halogen; R₂, R₂′, R₃, and R₃′ are —H; P is a polymeric chain, R₅ to R₁₂ are independently selected: —H, (C₁-C₂₀)alkyl, and (C₅-C₁₄)aryl;R₁₃ and R₁₄ are independently selected from (C₁-C₅)alkyl, and (C₅-C₁₄)aryl;, m is from 3 to 4; n is from 1 to 2; and p is from 1 to 2 provided that n+m+p sums 6; the polymer comprising from 5 to 25 weight % of urea moieties, and having H-bonding and pi-pi staking interactions between the urea groups, and a tensile strength comprised from 3 to 15 MPa.

The present invention relates to the field of polymer chemistry, more particularly to self-healable, reprocessable and recyclable materials. In particular, the invention relates to a self-healing, reprocessable and recyclable crosslinked polymer with improved mechanical properties and to a process for its preparation. The invention also relates to the use of this new reprocessable polymer.

### BACKGROUND ART

A lot of effort has recently been directed towards the design of polymeric materials which have the ability to spontaneously heal damage inflicted to them. Self-healing materials can be generally classified as achieving healing either extrinsically, via the triggered release of a pre-added healing agent (microencapsulation), or intrinsically, by reversible bond formation. A major limitation of the former is their inability to repeatedly heal the material at the same point, losing their self-healing power in each healing cycle, as the microencapsulated healing agent is consumed.

Although extrinsically self-healing materials can be used for very specific applications, intrinsically self-healing polymers have become more appealing because of their ability to repeatedly heal at the same damage site. A number of reversible or dynamic bonds, both covalent and non-covalent, have been introduced in polymers and gels to impart self-healing properties. For example, non-covalent or supramolecular interactions such as H-bonding and metal-ligand complexation have been successfully used to make self-healing polymers. The introduction of such dynamic bonds into polymer networks results in other interesting features, i.e. reprocessability and recyclability. In this sense, some recent work has been published in the literature (Damien Montarnal, et al., “Silica-Like Malleable Materials from Permanent Organic Networks”, 2011, Science, vol. 334, p. 965; Martin R. et al., “The processability of a poly(urea-urethane) elastomer reversibly crosslinked with aromatic disulfide bridges”, 2014, Journal of Materials Chemistry A, vol. 2, p. 5710).

Polymer networks or thermoset materials are widely used as they offer high thermal stability, good mechanical properties and resistance to creep. However, they have currently a great barrier because once a thermoset material is formed, it cannot be remoulded or reshaped and therefore the recycling or reusing of thermoset polymers is extremely difficult.

A self-healing, reprocessable and recyclable poly(urea-urethane) (PUU) recently developed by Rekondo A. et. al (Rekondo A. et al., “Catalyst-free room-temperature self-healing elastomers based on aromatic disulfide metathesis”, 2013, Materials Horizons, vol. 1, p. 237; Martin R. et al. (supra)) have demonstrated that aromatic disulfide crosslinks can be used for the construction of elastomers with quantitative self-healing power at room-temperature. The development of this material was a breakthrough in the field of self-healing materials and had a major impact for worldwide companies of different sectors. However, this material still has some limitations for its industrial implementation in some very exigent sectors, such as, limited mechanical properties, instability towards reducing agents, high cost of disulfide crosslinker, yellowish color and relatively long times for self-healing. Thus, it would be desirable to overcome these limitations and create a new generation of polymers with improved mechanical properties.

### SUMMARY OF THE INVENTION

The inventors of the present invention have developed a cross-linked polymer material showing superior mechanical properties when compared with the polymer disclosed in Rekondo A. et al. and in Martin R. et al. (supra). In particular, the tensile strength value of the PUU disclosed in Rekondo and Martin was about 0.8 MPa, whereas as shown below, the polymer of the invention has a value at least 4-fold higher. From these data, it can be concluded that the polymer of the invention is harder than the one of the prior art.

In addition, it has been found that the polymer can be conveniently reprocessed and recycled, and that such processes do not negatively affect to its improved mechanical properties, as it is shown below.

Moreover, it has been found that the polymer present high self-healing ability at room temperature, without the need of any catalyst or external stimulus, as it is shown below.
Thus, the present invention provides in a first aspect a self-healing, reprocessable and recyclable crosslinked polymer comprising units of formula (I)

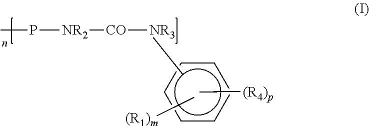

wherein

R₄ is a radical selected from the group consisting of radicals of formula (II), (III), and (IV):

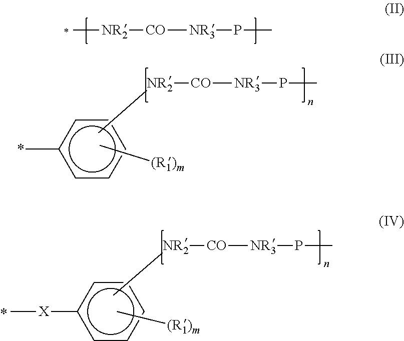

R₁ and R₁′ are radicals independently selected from the group consisting of: —H, (C₁-C₂₀))alkyl, C₅-C₁₄)aryl, —OR₅,—(CO)R_{6,} —O(CO)R_{7,} —(SO)R_{8,} —NH—CO—₉, —COOR₁₀, —NR₁₁R₁₂, —NO₂, and halogen;

R₂, R₂′, R₃, and R₃′ are —H;

P is a polymeric chain,

*denotes the position through which radical R₄ binds to the phenyl ring of the unit of formula (I),

X is a biradical selected from the group consisting of: —CH₂—, —O—, —S—, —CO—, —S(O₂)—, —Si(R₁₃R₁₄)—, —NH—;

R₅ to R₁₂ are radicals independently selected from the group consisting of: —H, (C₁-C₂₀)alkyl, and C₅-C₁₄)aryl;

R₁₃ and R₁₄ are radicals independently selected from the group consisting of (C₁-C₅)alkyl, and (C₅-C₁₄)aryl;

(C₅-C₁₄)aryl represents a ring system with 1-3 rings which comprises from 5 to 14 carbon atoms, the rings being saturated, partially unsaturated, or aromatic; and being fused, partially fused or isolated; being at least one of the rings an aromatic ring; and the ring system being optionally substituted by one or more radicals independently selected from the group consisting of (C₁-C₆)alkyl, (C₁-C₆)haloalkyl, (C₁-C₆)alkoxy, nitro, cyano, and halogen;

m is from 3 to 4; and

n is from 1 to 2;

p is from 1 to 2; provided that n+m+p is 6;

the crosslinked polymer comprising from 5 to 25 weight % of urea moieties, and having H-bonding and pi-pi staking interactions between the urea groups, and a tensile strength comprised from 3 to 15 MPa;

the tensile strength being measured following determined UNE-EN-ISO 527 standard, which comprises the stretching of dumbbell-shaped specimens of normalized dimensions at an elongation rate of 500 mm min⁻¹, and measuring the value of stress (MPa) until the specimen is broken.

In another aspect it is provided a self-healing, reprocessable and recyclable crosslinked polymer comprising units of formula (I)

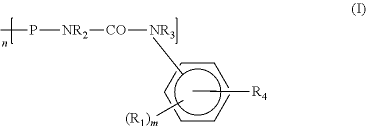

wherein

R₄ is a radical selected from the group consisting of radicals of formula (II), (III), and (IV):

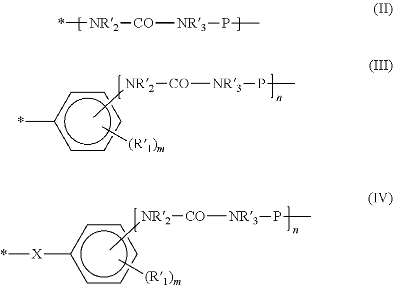

R₁ and R₁′ are radicals independently selected from the group consisting of: —H, (C₁-C₂₀))alkyl, C₅-C₁₄)aryl, —OR₅,—(CO)R_{6,} —O(CO)R_{7,} —(SO)R_{8,} —NH—CO—R₉, —COOR₁₀, —NR₁₁R₁₂, —NO₂, and halogen;

R₂, R₂′, R₃, and R₃′ are —H;

P is a polymeric chain,

*denotes the position through which radical R₄ binds to the phenyl ring of the unit of formula (I),

X is a biradical selected from the group consisting of: —CH₂—, —O—, —S—, —CO—, —S(O₂)—, —Si(R₁₃R₁₄)—, —NH—;

R₅ to R₁₂ are radicals independently selected from the group consisting of: —H, (C₁-C₂₀)alkyl, and C₅-C₁₄)aryl;

R₁₃ and R₁₄ are radicals independently selected from the group consisting of (C₁-C₅)alkyl, and (C₅-C₁₄)aryl;

(C₅-C₁₄)aryl represents a ring system with 1-3 rings which comprises from 5 to 14 carbon atoms, the rings being saturated, partially unsaturated, or aromatic; and being fused, partially fused or isolated; being at least one of the rings an aromatic ring; and the ring system being optionally substituted by one or more radicals independently selected from the group consisting of (C₁-C₆)alkyl, (C₁-C₆)haloalkyl, (C₁-C₆)alkoxy, nitro, cyano, and halogen;

m is from 3 to 4, and

n is from 1 to 2; provided that n+m is 5;

the crosslinked polymer comprising from 5 to 25 weight % of urea moieties, and having H-bonding and pi-pi staking interactions between the urea groups, and a tensile strength comprised from 3 to 15 MPa;

the tensile strength being measured following determined UNE-EN-ISO 527 standard, which comprises the stretching of dumbbell-shaped specimens of normalized dimensions at an elongation rate of 500 mm min⁻¹, and measuring the value of stress (MPa) until the specimen is broken.

As shown below, the crosslinked polymer of the invention can be re-shaped or reprocessed by applying suitable temperature and pressure conditions without the need of any catalyst. It can also be recycled from its powder state.

Surprisingly, the reprocessed or recycled material exhibits the same or higher tensile strength compared to the pristine polymer composition (Table 2). FIG. 1 shows a photographic sequence of a typical recycling process. First, a pristine cylinder made from the polymer composition of the first aspect of the invention was milled to a fine powder using a cutting mill. Then the powder was hot-pressed inside a frame and allowed to stand at 160° C., under 50 bar pressure for 1 hour. This permits to use the recycled materials in the same application where the pristine material was used, as the properties of the recycled material are as good as the initial ones. In addition, the possibility of reprocessing these materials from their powder state permits the fabrication of poly(urea-urethane) components without the manipulation of highly toxic isocyanates by the component manufacturer.

Moreover, the self-healing process of the polymer of the invention takes place in a very short period of time and without the need of any catalyst or external stimulus, such as heat or light. Thus, when the polymer is cut in half and the two pieces are put in contact together, it self-heals in a matter of 1 hour. FIG. 2 shows a photographic sequence of a typical healing process. First, a pristine cylinder made from the polymer composition of the first aspect of the invention was cut in half with a knife. Then the two halves were put in contact and allowed to stand at room-temperature, without applying any pressure. After 1 hour it was already not possible to separate the two pieces by stretching manually.

In addition to the above, the self-healing efficiency of the polymer of the invention was quantified by tensile strength measurements. As it is shown in Table 1, three polymers, embodiments of the first aspect of the invention, were prepared. The mended samples after 1 h showed a tensile strength of 3.5, 2.3 and 1.1 MPa., which can be considered a quite remarkable result for a crosslinked polymer composition.

The crosslinked polymer composition of the invention comprises aromatic ureas of formula (I). Without being bound to the theory, the present inventors believe that the surprising profile of the polymer comprising the units of formula (I), i.e., self-healing, reprocessability, recyclability and improved tensile strength, is due to: 1) the strong multiple H-bonds and pi-pi stacking interactions between urea groups and aromatic rings, respectively (see FIG. 3). To obtain such strong interactions, it is necessary that the urea groups are attached to a rigid and quasi-planar aromatic structure. The distance between urea groups and their conformation also determine the nature of the interaction between them and, therefore, determine the possibility of forming such strong multiple H-bonds and pi-pi stacking interactions. Such conditions can only be achieved when the urea groups are attached to the same aromatic ring, or to different aromatic rings, such rings being bridged by one bond (being both rings directly attached) or two chemical bonds (separated by an atom) as depicted in formula (I). FIG. 3 shows a schematic representation of such interactions. 2) the possibility of undergoing urea exchange or transureization reactions under heat and pressure, which, are responsible for the efficient recyclability and reprocessability of the material. Without being bond to the theory, the authors think that such transureization reactions are favored when the urea groups are directly attached to the aromatic rings. Transureization of highly hindered ureas has been reported to occur at relatively low temperature both in solution and inside a polymer matrix (Hanze Y. “Dynamic urea bond for the design of reversible and self-healing polymers”, 2014, Nature Communications, v. 5, p. 1-9). Surprisingly, the polymer composition of the present invention is capable of undergo this urea exchange reaction at higher temperatures without the need of bulky substituents. Bulky substituents, or substituted ureas in general, on the other hand, do not permit the formation of H-bonds.

As it has been stated above, when compared with the polymer disclosed in Rekondo A. et al., (supra), the polymer of the present invention shows improved tensile strength, being at least 4-fold increased. These data supports the fact that reducing the distance between the urea groups which are attached to the aromatic system, a tremendous improvement in the mechanical properties can be obtained.

Surprisingly, as it is shown in the examples below, the polymer of the first aspect of the invention exhibits a high and fast self-healing ability at room temperature compared with other polymers described in the state of the art.

Depending on the specific formulation, the self-healing efficiency of the material of the invention can vary from 15 to 100% (see Table 1). However, the polymer compositions containing the aromatic ureas of formula (I) present considerably higher initial mechanical properties when compared with Rekondo A. et al., supra, and thus, the absolute tensile strength values of healed samples are much higher than in previously reported self-healing elastomeric materials of the prior state of the art (see Table 3).

Advantageously, the polymer of the first aspect of the invention can be easily synthesized from unexpensive and readily available starting materials.

Thus, in a second aspect, the present invention provides a process for preparing a self-healing, reprocessable and recyclable polymer as defined in the first aspect of the invention, the process comprising the reaction between an isocyanate-functionalised polymer with functionality equal or higher than 2 with an aromatic compound of formula (VI)

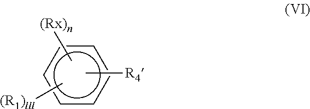

wherein

R₄′ is selected from the group consisting of radicals of formula (VII), (VIII), and (IX)

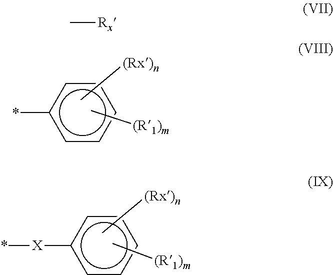

R₁, R₁′, X, m, and n are as defined above,

Rₓ and Rₓ′ represents —NH₂

or alternatively,

the reaction of a primary amine-functionalised polymer with amine functionality equal or higher than 2 with an aromatic compound of formula (X)

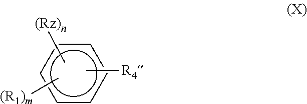

wherein

R₄″ is selected from the group consisting of radicals of formula (XI), (XII), and (XIII)

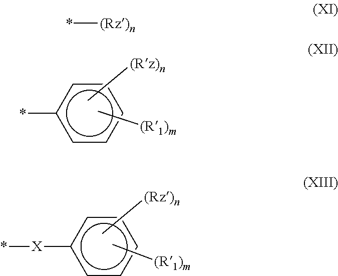

wherein
R₁, R₁′, X, m, and n are as defined above,
R_{z} and R_{z}′ represents —NCO,

the reaction being performed, in any of the alternatives, at a temperature comprised from −30 to 200° C. and wherein the molar ratio between amine and isocyanate groups is from 1.0 to 1.8.

The self-healing and reprocessable polymer of the invention can also be defined by its preparation process. Thus, in a third aspect the present invention provides a self-healing, reprocessable and recyclable polymer obtainable by the process of the invention described above.

One of the special features shown by the crosslinked polymer of the present invention is that it can be recycled.

In a fourth aspect, the present invention provides a process for recycling a crosslinked polymer as defined in the first aspect of the invention, the process comprising subjecting the polymer, to heat and pressure.

Surprisingly, and as it is shown in the examples below, when the polymer of the first aspect of the invention is recycled, the mechanical properties, such as tensile strength and elongation at break, are maintained or slightly improved when compared with the pristine polymer.

Therefore, in a fifth aspect the present invention provides a recycled polymer obtainable by the process defined in the fourth aspect of the invention.

In view of the above, the polymer of the first aspect of the invention shows adhesive properties at room-temperature.

Therefore, in a sixth aspect the present invention provides the use of the polymer composition of the first aspect of the invention as an adhesive.

In addition to the above, it was confirmed that the crosslinked polymer of the invention can stand an elongation of 100% for at least 24 hours following ISO 11600. In fact, as it is shown below, the material of the invention shows an elongation at break around 1000% when it is tested following ISO 527. This means that the original size can be increased 10-fold without breaking. This feature is of great importance in some fields such as construction sector, wherein the ISO11600 requirements specify that a material can only be used as a construction sealant when it can stand an elongation of 100% for at least 24 hours without breaking.

Therefore, in view of the above, the present invention provides the use of the polymer composition as defined in the first aspect of the invention as construction sealant.

In another aspect, the invention relates to an article of manufacture made of the polymer composition of the invention.

In still another aspect, the invention relates to a process for the manufacture of an article as defined above, the process comprising forming the article from the self-healing, reprocessable, and recyclable polymer composition of the invention.

### BRIEF DESCRIPTION OF THE DRAWINGS

FIG. 1 Transparent cylinder of one polymer composition of the invention grinded in the form of powder which was placed in a 2 mm mould and reprocessed at 160° C. and 50 bar for 1 hour to give a film.

FIG. 2 Photographic sequence of a pristine cylindrical sample of a polymer composition of the invention (a) which was cut in half (b,c). the two halves were then allowed to stand for 1 hour by simple contact (d). After that time the material could be manually stretched without rupture (e).

FIG. 3 Proposed interactions involved in the self-healing mechanism of the polymer of the present invention.

FIG. 4. FTIR spectra of reaction of PPG (Mₙ6 kDa) and IPDI at 70° C. at t=0 (solid line) and t=45 min. (dotted line), where the appearance of new bands corresponding to the carbonyl group of urethane moiety at 1720 cm⁻¹ and amide II at 1534 cm⁻¹ can be observed. Moreover, a decrease and displacement of the NCO stretching band from 2258 to 2264 cm⁻¹ can be observed, which was used as criteria to establish that the reaction was finished.

FIG. 5. FTIR spectra of reaction of PPG (Mₙ4 kDa) and IPDI at 70° C. at t=0 (solid line) and t=45 min. (dotted line), where the appearance of new bands corresponding to the carbonyl group of urethane moiety at 1720 cm⁻¹ and amide II at 1534 cm⁻¹ can be observed. Moreover, a decrease and displacement of the NCO stretching band from 2258 to 2264 cm⁻¹ can be observed, which was used as criteria to establish that the reaction was finished.

FIG. 6. FTIR spectra of reaction of PPG (Mₙ2 kDa) and IPDI at 60° C. at t=0 min (solid line) and t=70 min. (dotted line), where the appearance of new bands corresponding to the carbonyl group of urethane moiety at 1720 cm⁻¹ and amide II at 1534 cm⁻¹ can be observed. Moreover, a decrease and displacement of the NCO stretching band from 2258 to 2264 cm⁻¹ can be observed, which was used as criteria to establish that the reaction was finished.

FIG. 7. FTIR spectra of reaction of PPG (Mₙ1 kDa) and IPDI at 60° C. at t=0 min (solid line) and t=70 min. (dotted line), where the appearance of new bands corresponding to the carbonyl group of urethane moiety at 1720 cm⁻¹ and amide II at 1534 cm⁻¹ can be observed. Moreover, a decrease and displacement of the NCO stretching band from 2258 to 2264 cm⁻¹ can be observed, which was used as criteria to establish that the reaction was finished.

FIG. 8. FTIR spectra recorded during the synthesis of PUU1 (Example 5) at different curing times (a=0; b=1 h;c=2 h and d=12 h). At t=12 h, the NCO stretching band at 2264 cm⁻¹ completely disappeared and a new band corresponding to the urea appeared at 1650 cm⁻¹ in the form of a shoulder. The spectra have been shifted for clarity.

FIG. 9. FTIR spectra recorded during the synthesis of PUU2 (Example 6) at different curing times (a=0; b=2 h and c=12 h). At t=12 h, the NCO stretching band at 2264 cm⁻¹ completely disappeared and a new band corresponding to the urea appeared at 1650 cm in the form of a shoulder. The spectra have been shifted for clarity.

FIG. 10. FTIR spectra recorded during the synthesis of PUU3 (Example 7) at different curing times (a=0; b=1 h; c=2 h and d=12 h). At t=12 h, the NCO stretching band at 2264 cm⁻¹ completely disappeared and a new band corresponding to the urea appeared at 1650 cm⁻¹ in the form of a shoulder. The spectra have been shifted for clarity.

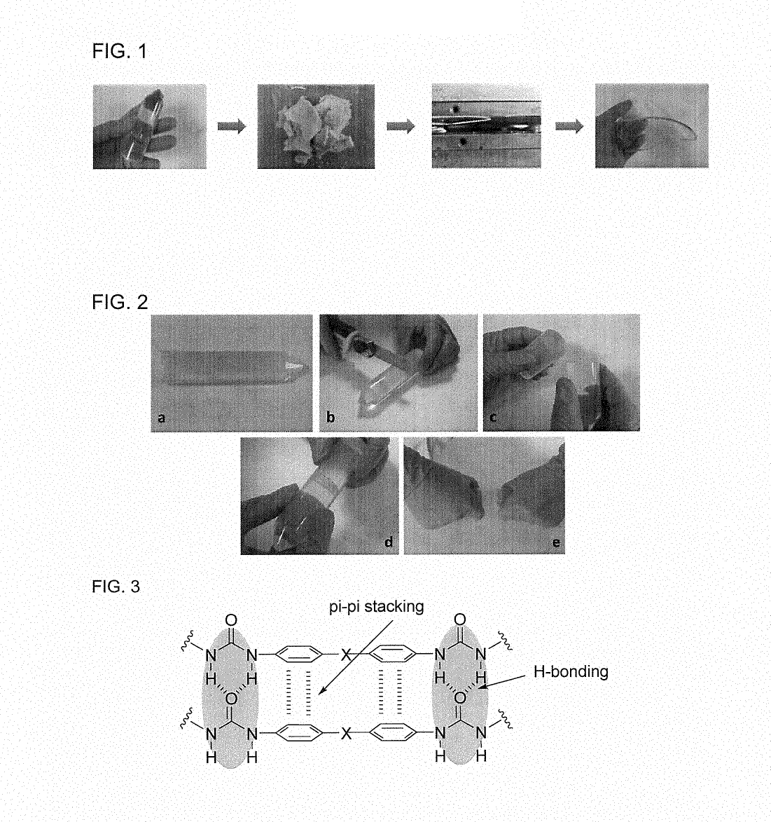

### DETAILED DESCRIPTION

The term “polymer” refers to a macromolecule composed of many repeated subunits, known as monomers. Polymers, both natural and synthetic, are created via polymerization of many monomers. The polymer is composed of polymer chains, said chains being typically linear or branched.

The term “reprocessable” is to be understood as that the polymer can change its form, applying pressure and heat. The selection of specific pressure and heat conditions will depend on the specific nature of the material and shape of final part. Forms part of the routine tasks of the skilled person in the art the selection of appropriate pressure and heat conditions.

The term “recyclable” is to be understood as that the polymer can be grinded and remanufactured applying pressure and heat. The selection of specific pressure and heat conditions will depend on the specific nature of the material and shape of final part. Forms part of the routine tasks of the skilled person in the art the selection of appropriate pressure and heat conditions.

The term “self-healing efficiency” is to be understood as the percentage of tensile strength recovery of the self-healed specimens.

The term “cross-linked polymer” (also referred to as a network or thermoset polymer) refers to a polymer wherein different polymeric chains (such as oligomers), which can be linear or branched, are linked through at least covalent bonds. In one embodiment, all the chains forming the polymer are cross-linked. In another embodiment, about from 10 to 85% of the chains forming the polymer are cross-linked.

The term “percentage (%) by weight” refers to the percentage of each ingredient of the polymer or mixture, when applicable, in relation to the total weight.

The term “functionality equal or higher than 2” when referred to the isocyanate-functionalised polymer or the amine-functionalised polymer, means that the polymer comprises at least two isocyanate or amine groups, respectively. In one embodiment, the isocyanate-functionalised polymer or the amine-functionalised polymer comprises from 2 to 100 isocyanate or amine groups, respectively. In another embodiment, the isocyanate-functionalised polymer or the amine-functionalised polymer comprises from 2 to 20 isocyanate or amine groups, respectively. In still another embodiment, the isocyanate-functionalised polymer or the amine-functionalised polymer comprises from 2 to 10 isocyanate or amine groups, respectively. In still another embodiment, the isocyanate-functionalised polymer or the amine-functionalised polymer comprises from 2 to 3 isocyanate or amine groups, respectively.

In the present invention, the terms “cured”/“curing” and “cross-linked”/“cross-linking” have the same meaning and can be used interchangeably.

According to the present invention when the ring system is formed by “isolated” rings means that the ring system is formed by two, three or four rings and said rings are bound via a bond from the atom of one ring to the atom of the other ring. The term “isolated” also embraces the embodiment in which the ring system has only one ring. Illustrative non-limitative examples of known ring systems consisting of one ring are those derived from: cyclopropyl, cyclobutyl, cyclopentyl, cyclohexyl, cycloheptyl, cyclopropenyl, cyclobutenyl, cyclopentenyl, phenyl, and cycloheptenyl.

According to the present invention when the ring system has rings “totally fused”, means that the ring system is formed by two, three or four rings in which two or more atoms are common to two adjoining rings. Illustrative non-limitative examples are 1,2,3,4-tetrahydronaphthyl, 1-naphthyl, 2-naphthyl, anthryl, or phenanthryl.

According to the present invention when the ring system is “partially fused” it means that the ring system is formed by three or four rings, being at least two of said rings totally fused (i.e. two or more atoms being common to the two adjoining rings) and the remaining ring(s) being bound via a bond from the atom of one ring to the atom of one of the fused rings.

Throughout the description and claims, the term (C₁-C₂₀)alkyl shall be construed as straight or branched.

The term “molar ratio” refers to the relation of moles of amine:isocyanate reactive groups.

The term “room-temperature” denotes a temperature comprised from 10 to 35° C.

The parameter “tensile strength” is the maximum stress that a material can withstand while being stretched or pulled before failing or breaking. The parameter “elongation at break” is the maximum elongation that a material can withstand while being stretched or pulled before failing or breaking. These two parameters have been determined following UNE-EN-ISO 527 standard. Briefly, dumbbell-shaped specimens of normalized dimensions are stretched at an elongation rate of 500 mm min⁻¹ and the values of stress (MPa) and elongation (%) are measured and monitored until the specimen is broken.

The term “curing” refers to the toughening or hardening of a polymer material by cross-linking of polymer chains, brought about by chemical additives, ultraviolet radiation, electron beam or heat. In this process the resin viscosity drops initially upon the application of heat, passes through a region of maximum flow and begins to increase as the chemical reactions increase the average length and the degree of cross-linking between the constituent polymers. This process continues until a continuous 3-dimensional network of polymer chains is created— this stage is termed gelation.

The term “obtainable” and “obtained” have the same meaning and are used interchangeably. In any case, the expression “obtainable” encompasses.

As it has been stated above, the present invention provides a self-healing, reprocessable and recyclable cross-linked polymer.

In one embodiment of the first aspect of the invention, the weight % of urea moieties is comprised from 8 to 16%. In another embodiment, the weight % of urea moieties is selected from 8, 9, 10, 11, 12, 13, 14, 15, and 16.

In another embodiment of the first aspect of the invention, the tensile strength of the polymer is comprised from 4 to 10 MPa.

In one embodiment, the polymer of the invention is transparent and colorless.

Unexpectedly, and overcoming the teachings of the prior art, the present invention provides, for the first time, a transparent and colorless crosslinked polymer composition with superior self-healing properties and reprocessing ability based on H-bonds and urea exchange, respectively.

In one embodiment, P is a polyurethane polymer.

In another embodiment, the polymer is a poly(urea)urethane.

Poly(urea-urethane)s can be formulated as monocomponent or bicomponent systems, wherein firstly it is prepared an isocyanate-functionalised polymer (by reacting a polyol resin with a diisocyanate or polyisocyanate component) which is crosslinked with polyamines (bicomponent systems) or by ambient humidity (monocomponent systems). The fact that poly(urea-urethane)s are widely used in industrial applications such as RIM-processed automotive components, sealants, adhesives, paints and coatings, insulating foams, etc., makes the polymer composition of the invention very attractive for a fast and easy implementation in real industrial applications.

In another embodiment, the crosslinked polymer is one of formula (V)

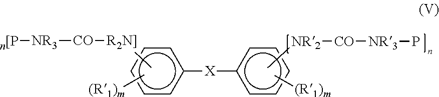

wherein R₁, R₁′, R₂, R₂′, R₃, R₃′, X, m, and n are as defined above.

In another embodiment of the polymer of the first aspect of the invention, n is 1.

In another embodiment of the polymer of the first aspect of the invention, n is 1 and the urea birradicals are in para-position relative to the X biradical.

In another embodiment of the polymer of the first aspect of the invention, R₁, R₁′, R₂, R₂′, R₃ and R₃′ are —H.

In another embodiment of the polymer of the first aspect of the invention, m is 4 and R₁, R₁′, R₂, R₂′, R₃ and R₃′ are —H.

In still another embodiment of the polymer of the first aspect of the invention, the unit of formula (I) is

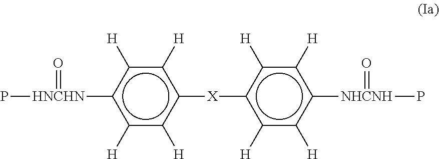

wherein P means a polyurethane polymer, and X is as defined above.

In still yet another embodiment of the polymer of the first aspect of the invention, X is —CH₂—.

In still yet another embodiment of the polymer of the first aspect of the invention, the units are of formula (Ia′)

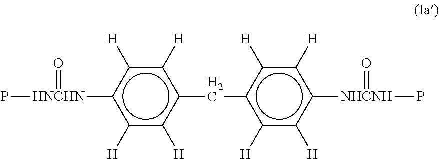

wherein P means a polyurethane polymer.

In a second aspect, the present invention provides a process for preparing a polymer as defined in the first aspect of the invention.

In one embodiment of the process of the second aspect of the invention, the temperature is comprised from −30 to 150° C.

In another embodiment of the process of the second aspect of the invention, the temperature is comprised from 0 to 100° C.

In another embodiment of the process of the second aspect of the invention, the temperature is comprised from 20 to 80° C.

In another embodiment of the process of the second aspect of the invention, the temperature is comprised from 50 to 75° C.

In another embodiment of the process of the second aspect of the invention, the temperature is 70° C.

In still another embodiment of the process of the second aspect of the invention, the molar ratio between amine and isocyanate groups is from 1.0 to 1.8.

In still another embodiment, the molar ratio between amine and isocyanate groups is from 1.0 to 1.5.

In still another embodiment, the molar ratio between amine and isocyanate groups is from 1.1 to 1.3.

In still another embodiment, the molar ratio between amine and isocyanate groups is one selected from the group consisting of: 1.0, 1.1, 1.2, 1.3, 1.4, 1.5, 1.6, 1.7, and 1.8. In still yet another embodiment, the molar ratio between amine and isocyanate groups is comprised from 1.2 to 1.8. In still yet another embodiment, the molar ratio between amine and isocyanate groups is comprised from 1.3 to 1.8.

In still yet another embodiment, the molar ratio between amine and isocyanate is 1.1.

In still yet another embodiment, the molar ratio between amine and isocyanate is 1.3.

In one embodiment of the second aspect of the invention, the process comprises reacting an isocyanate-functionalised polymer with an aromatic amine of formula (VI).

In another embodiment, the isocyanate-functionalised polymer is a isocyanate-functionalised polyurethane with a % NCO content from 1 to 15% (weight percent).

In another embodiment, the isocyanate-functionalised polymer is a tris- or a mixture of tris- and bis-isocyanate-terminated polymers.

In another embodiment, the isocyanate-functionalised polymer is a tris- or a mixture of tris- and bis-isocyanate-terminated polyurethane polymer.

These isocyanate terminated polymers can be any commercially available or can be synthesized following well-known methods (E. Delebecq, J.-P. et al., 2012; and U.S. Pat. No. 3,905,944).

Particularly, precursors which can be used for the preparation of isocyanate-terminated polymers include, but are not limited to:

synthetic polymers: polyethylene glycol (PEG), polypropylene glycol (PPG), polytetramethylene glycol (PTMG), acrylates, methacrylates, polyesters, polycaprolactones, polyacids, polyvinyl alcohol (PVA), polydimethylsiloxane (PDMS), calcium polycarbophil, deacetylated gellan gum;

natural polymers: castor oil, soybean oil, polysaccharides such as chitosan, sodium or calcium carboxymethylcellulose, sodium alginate, condroitin sulphate, sodium hydroxypropylcellulose, hyaluronic acid, pectin; peptides, proteins, and oligonucleotides; polyisoprenes, and

mixtures of the above mentioned synthetic and natural polymers or copolymers made there from.

Accordingly, in one embodiment, the precursor giving rise to the isocyanate-terminated polymer chain is selected from the group consisting of calcium polycarbophil (a copolymer of acrylic acid and divinyl glycol), chitosan, sodium carboxymethylcellulose, calcium carboxymethylcellulose, sodium alginate, condroitin sulphate, sodium hydroxypropylcellulose, hyaluronic acid, pectin, poly(acrylic acid), poly(methacrylic acid), polyacrylamide, deacetylated gellan gum, polyethylene glycol, polypropylene glycol (PPG), castor oil, soybean oil, polyvinyl alcohol, polycaprolactone, and mixtures thereof.

In another embodiment, the precursor giving rise to the isocyanate-terminated polymer chain is a non-water-soluble polymer whose Tg (glass transition temperature) is below room-temperature, such as PPG, castor oil or polyesters, among others.

In another embodiment, the precursor of the isocyanate-terminated polymer is a tris-OH terminated PPG.

In one embodiment, the tris-OH terminated PPG has an average molecular weight from 150 to 20000 g/mol.

In another embodiment, the tris-OH terminated PPG has an average molecular weight from 1000 to 10000 g/mol.

In another embodiment, the tris-OH terminated PPG has an average molecular weight from 2000 to 8000 g/mol.

In another embodiment, the tris-OH terminated PPG has an average molecular weight from 3500 to 7000 g/mol.

In another embodiment, the precursor of the isocyanate-terminated polymer is a bis-OH terminated PPG.

In another embodiment, the bis-OH terminated PPG has an average molecular weight from 150 to 20000 g/mol.

In another embodiment, the bis-OH terminated PPG has an average molecular weight from 500 to 8000 g/mol.

In another embodiment, the bis-OH terminated PPG has an average molecular weight from 1000 to 5000 g/mol

In another embodiment, the bis-OH terminated PPG has an average molecular weight from 1000 to 3000 g/mol.

In another embodiment, the bis-OH terminated PPG has an average molecular weight from 1000 to 2000 g/mol.

In another embodiment, the PPG reacts with an isocyanate compound in order to obtain an isocyanate terminated polymer.

In one embodiment, the tris-OH terminated PPG reacts with an isocyanate compound in order to obtain a tris-isocyanate terminated polymer.

In another embodiment, the bis-OH terminated PPG reacts with an isocyanate compound in order to obtain a bis-isocyanate terminated polymer.

In another embodiment, the isocyanate compound is a diisocyanate compound which is selected from isophorone diisocyanate (IPDI), 4,4′-methylene diphenyl diisocyanate (MDI), toluene 2,4-diisocyanate (TDI), 1,4-tetramethylenediisocyanate, 1,6-hexamethylenediisocyanate (HDI), 1,1, o-decamethylenediisocyanate, 1,5-naphthalenediisocyanate, curnene2, 4-diisocyanate, 4-methoxy-1,3-phenylenediisocyanate, 4-chloro 1,3-phenylenediisocyanate, 4-bromo 1,3 phenylenediisocyanate, 4-ethoxy 1,3-phenylenediisocyanate, 2,4-diisocyanatodiphenylether, 5, 6-dimethyl 1,3-phenylenediisocyanate, 2,4-dimethyl 1,3-phenylenediisocyanate, 4,4′-diisocyanatodiphenylether, benzidinediisocyanate, 4,6-dimethyl 1,3-phenylenediiisocyanate, 9,10-anthracenediisocyanate, 4,4-diisocyanatodibenzyl, 3,3 ‘-dimethyl-4,4-diisocyanatodiphenylmethane, 2,6diisocyanatostilbene, 3,3-dimethyl-4,4-diisocyanatodiphenyl, 3,3-dimethoxy-4,4’-diisocyanatodiphenyl, 1,4-anthracenediisocyanate, 2,5-fluorenediisocyanate, 1,5-naphthalenediisocyanate, 1,3-phenylenediisocyanate, 2,6-diisocyanatobenzfuran; 2,4-toluenetriisocyanate and 2,4,4-triisocyanatodiphenylether.

In another embodiment, the isocyanate compound is isophorone diisocyanate (IPDI).

In one embodiment, the tris-OH terminated PPG reacts with IPDI in order to obtain a tris-isocyanate terminated polymer.

In another embodiment, the bis-OH terminated PPG reacts with IPDI in order to obtain a bis-isocyanate terminated polymer.

In another embodiment, the tris-OH terminated PPG having an average molecular weight comprised from 2000 to 8000 g/mol reacts with IPDI in order to obtain a tris-isocyanate terminated polymer.

In one embodiment, the tris-OH terminated PPG having an average molecular weight from about 3500 to 7000 g/mol reacts with IPDI in order to obtain a tris-isocyanate terminated polymer.

In one embodiment, the bis-OH terminated PPG having an average molecular weight from about 500 to 8000 g/mol reacts with IPDI in order to obtain a bis-isocyanate terminated polymer.

In one embodiment, the bis-OH terminated PPG having an average molecular weight comprised from 1000 to 5000 g/mol reacts with IPDI in order to obtain a bis-isocyanate terminated polymer.

In one embodiment, the bis-OH terminated PPG having an average molecular weight comprised from 1000 to 3000 g/mol reacts with IPDI in order to obtain a bis-isocyanate terminated polymer.

In one embodiment, the bis-OH terminated PPG having an average molecular weight comprised from 1000 to 2000 g/mol reacts with IPDI in order to obtain a bis-isocyanate terminated polymer.

In another embodiment of the process of the second aspect of the invention, the expression “an isocyanate-functionalised polymer” corresponds to a mixture of a tris-isocyanate terminated polymer and a bis-isocyanate terminated polymer.

In one embodiment of the process of the second aspect of the invention, the mixture of isocyanate-terminated polymers comprises from 30 to 70 weight % of a tris-isocyanate terminated polymer and from 30 to 70 weight % of a bis-isocyanate terminated polymer.

In another embodiment of the process of the second aspect of the invention, the mixture of isocyanate-terminated polymers comprises 40 weight % of a tris-isocyanate terminated polymer and 60 weight % of a bis-isocyanate terminated polymer.

In another embodiment of the process of the second aspect of the invention, the mixture of isocyanate-terminated polymers comprises 70 weight % of a tris-isocyanate terminated polymer and 30 weight % of a bis-isocyanate terminated polymer.

In another embodiment of the second aspect of the invention, the compound of formula (VI) is one wherein R₄′ is one of formula (IX)

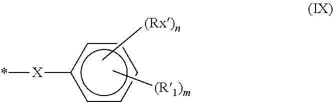

wherein R₁, R₁′, X, m, and n are as defined above.

In another embodiment, the compound of formula (VI) corresponds to one of formula (VIa):

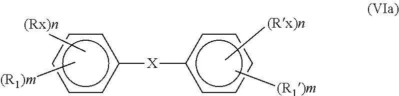

wherein R₁, R₁′, Rₓ, R′ₓ, m, n, and X are as defined above.

In another embodiment of the second aspect of the invention, the compound of formula (VIa) is one wherein n is 1.

In another embodiment of the second aspect of the invention, the compound of formula (VIa) is one wherein R₁, and R₁′ are the same.

In another embodiment of the second aspect of the invention, the compound of formula (VIa) is one wherein R₁, and R₁′ are —H.

In another embodiment of the second aspect of the invention, the compound of formula (VIa) is one wherein m is 4 and R₁, and R₁′ are —H.

In still yet another embodiment of the second aspect of the invention, the compound of formula (VIa) is one wherein X is —CH₂—.

In still yet another embodiment of the second aspect of the invention, the compound of formula (VI) or (VIa) is one of formula (VIa′)

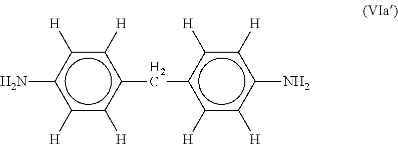

In another embodiment of the second aspect, the process comprises reacting a tris-isocyanate terminated polymer, or a mixture of tris- and bis-isocyanate terminated polymers, with a compound of formula (VIa) at a temperature comprised from 10 to 150° C. and wherein the molar ratio between the amine and isocyanate reactive groups is from 1.0 to 1.8.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is from 70 to 30% by weight and the tris-isocyanate terminated polymer content is from 30 to 70% by weight, the process comprises reacting an isocyanate-functionalised polymer with a compound of formula (VIa), at a temperature comprised from 10 to 150° C. and wherein the molar ratio between the amine and isocyanate reactive groups is from 1.0 to 1.8.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is 60% by weight and the tris-isocyanate terminated polymer content is from 40%, with a compound of formula (VIa) at a temperature comprised from 10 to 150° C. and wherein the molar ratio between the amine and isocyanate reactive groups is from 1.0 to 1.8.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is 60% by weight and the tris-isocyanate terminated polymer content is from 40%, with a compound of formula (VIa) at a temperature comprised from 20 to 80° C. and wherein the molar ratio between the amine and isocyanate reactive groups is from 1.0 to 1.8.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is 60% by weight and the tris-isocyanate terminated polymer content is from 40%, with a compound of formula (VIa) at a temperature comprised from 50 to 75° C. and wherein the molar ratio between the amine and isocyanate reactive groups is from 1.0 to 1.8.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is 60% by weight and the tris-isocyanate terminated polymer content is from 40% by weight, with a compound of formula (VIa) at a temperature of 70° C. and wherein the molar ratio between the amine and isocyanate reactive groups is from 1.0 to 1.8.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is 60% by weight and the tris-isocyanate terminated polymer content is from 40%, with a compound of formula (VIa) at a temperature comprised from 10 to 150° C. and wherein the molar ratio between the amine and isocyanate reactive groups is one selected from the group consisting of: 1.0, 1.1, 1.2, 1.3, 1.4, 1.5, 1.6, 1.7, and 1.8.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is 60% by weight and the tris-isocyanate terminated polymer content is from 40%, with a compound of formula (VIa) at a temperature comprised from 20 to 80° C. and wherein the molar ratio between the amine and isocyanate reactive groups is one selected from the group consisting of: 1.0, 1.1, 1.2, 1.3, 1.4, 1.5, 1.6, 1.7, and 1.8.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is 60% by weight and the tris-isocyanate terminated polymer content is from 40%, with a compound of formula (VIa) at a temperature comprised from 50 to 75° C. and wherein the molar ratio between the amine and isocyanate reactive groups is one selected from the group consisting of: 1.0, 1.1, 1.2, 1.3, 1.4, 1.5, 1.6, 1.7, and 1.8.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is 60% by weight and the tris-isocyanate terminated polymer content is from 40%, with a compound of formula (VIa) at a temperature of 70° C. and wherein the molar ratio between the amine and isocyanate reactive groups is one selected from the group consisting of: 1.0, 1.1, 1.2, 1.3, 1.4, 1.5, 1.6, 1.7, and 1.8.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is 60% by weight and the tris-isocyanate terminated polymer content is from 40%, with a compound of formula (VIa) at a temperature comprised from 10 to 150° C. and wherein the molar ratio between the amine and isocyanate reactive groups is comprised from 1.2 to 1.8.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is 60% by weight and the tris-isocyanate terminated polymer content is from 40%, with a compound of formula (VIa) at a temperature comprised from 20 to 80° C. and wherein the molar ratio between the amine and isocyanate is comprised from 1.2 to 1.8.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is 60% by weight and the tris-isocyanate terminated polymer content is from 40%, with a compound of formula (VIa) at a temperature comprised from 50 to 75° C. and wherein the molar ratio between the amine and isocyanate reactive groups is comprised from 1.2 to 1.8.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is 60% by weight and the tris-isocyanate terminated polymer content is from 40%, with a compound of formula (VIa) at a temperature of 70° C. and wherein the molar ratio between the amine and isocyanate reactive groups is comprised from 1.2 to 1.8.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is 60% by weight and the tris-isocyanate terminated polymer content is from 40%, with a compound of formula (VIa) at a temperature of 70° C. and wherein the molar ratio between the amine and isocyanate reactive groups is comprised from 1.1 to 1.3.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is 60% by weight and the tris-isocyanate terminated polymer content is from 40%, with a compound of formula (VIa) at a temperature of 70° C. and wherein the molar ratio between the amine and isocyanate reactive groups is 1.1.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is 60% by weight and the tris-isocyanate terminated polymer content is from 40%, with a compound of formula (VIa) at a temperature of 70° C. and wherein the molar ratio between the amine and isocyanate reactive groups is 1.3.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is from 30% to 70% by weight and the tris-isocyanate terminated polymer content is from 70 to 30%, with the compound of formula (VIa′) at a temperature comprised from 10 to 150° C. and wherein the molar ratio between the amine and isocyanate reactive groups is from 1.0 to 1.5.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is from 30% to 70% by weight and the tris-isocyanate terminated polymer content is from 70 to 30%, with the compound of formula (VIa′) at a temperature comprised from 20 to 80° C. and wherein the molar ratio between the amine and isocyanate reactive groups is from 1.0 to 1.5.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is from 30% to 70% by weight and the tris-isocyanate terminated polymer content is from 70 to 30%, with the compound of formula (VIa′) at a temperature comprised from 50 to 75° C. and wherein the molar ratio between the amine and isocyanate reactive groups is from 1.0 to 1.5.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is from 30% to 70% by weight and the tris-isocyanate terminated polymer content is from 70 to 30%, with the compound of formula (VIa′) at a temperature of 70° C. and wherein the molar ratio between the amine and isocyanate reactive groups is from 1.0 to 1.5.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is from 30% to 70% by weight and the tris-isocyanate terminated polymer content is from 70 to 30%, with the compound of formula (VIa′) at a temperature comprised from 10 to 150° C., for a period of time from 1 to 30 hours, and wherein the molar ratio between the amine and isocyanate reactive groups is from 1.0 to 1.5.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is from 30% to 70% by weight and the tris-isocyanate terminated polymer content is from 70 to 30%, with the compound of formula (VIa′) at a temperature comprised from 20 to 80° C., for a period of time from 1 to 30 hours, and wherein the molar ratio between the amine and isocyanate reactive groups is from 1.0 to 1.5.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is from 30% to 70% by weight and the tris-isocyanate terminated polymer content is from 70 to 30%, with the compound of formula (VIa′) at a temperature comprised from 50 to 75° C., for a period of time from 1 to 30 hours, and wherein the molar ratio between the amine and isocyanate reactive groups is from 1.0 to 1.5.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is from 50% to 90% by weight and the tris-isocyanate terminated polymer content is from 10 to 50%, with the compound of formula (VIa′) at a temperature of 70° C., for a period of time from 1 to 30 hours, and wherein the molar ratio between the amine and isocyanate reactive groups is from 1.0 to 1.5.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is from 30% to 70% by weight and the tris-isocyanate terminated polymer content is from 70 to 30%, with the compound of formula (VIa′) at a temperature comprised from 10 to 150° C., for a period of time from 5 to 20 hours, and wherein the molar ratio between the amine and isocyanate reactive groups is from 1.0 to 1.5.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is from 30% to 70% by weight and the tris-isocyanate terminated polymer content is from 70 to 30%, with the compound of formula (VIa′) at a temperature comprised from 20 to 80° C., for a period of time from 5 to 20 hours, and wherein the molar ratio between the amine and isocyanate reactive groups is from 1.0 to 1.5.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is from 30% to 70% by weight and the tris-isocyanate terminated polymer content is from 70 to 30%, with the compound of formula (VIa′) at a temperature comprised from 50 to 75° C., for a period of time from 5 to 20 hours, and wherein the molar ratio between the amine and isocyanate reactive groups is from 1.0 to 1.5.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is from 30% to 70% by weight and the tris-isocyanate terminated polymer content is from 70 to 30%, with the compound of formula (VIa′) at a temperature of 70° C., for a period of time from 5 to 20 hours, and wherein the molar ratio between the amine and isocyanate reactive groups is from 1.0 to 1.5.

In still another embodiment of the process of the second aspect of the invention, the reaction is performed at 70° C. for 16 hours.

In still another embodiment of the process of the second aspect of the invention, the reaction is performed at 70° C. for 8 hours.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is 60% by weight and the tris-isocyanate terminated polymer content is 40%, with the compound of formula (VIa′) at a temperature of 70° C., for a period of time from 5 to 20 hours, and wherein the molar ratio between the amine and isocyanate reactive groups is from 1.0 to 1.5. Preferably, the reaction is performed at 70° C. for 16 hours.

In another embodiment of the second aspect of the invention, the process comprises reacting: (a) a mixture comprising tris-isocyanate terminated polymer in an amount from 27 to 63% by weight, bis-isocyanate terminated polymer in an amount from 63 to 27% by weight, and one or more components selected from the group consisting of: solvents, plasticizers, pigments, organic or inorganic fillers, adhesion promoter, UV-stabilizers, rheology modifiers, flame-retardant additives and other functional additives, the total sum of bis-isocyanate terminated polymer, tris-isocyanate terminated polymer, and the one or more selected component(s) being 100% by weight; with (b) 4,4′-methylene dianiline (MDA), at a temperature comprised from 10 to 150° C. and wherein the molar ratio between the amine and isocyanate reactive groups is from 1.0 to 1.5.

In another embodiment of the second aspect of the invention, the process comprises reacting: (a) a mixture comprising tris-isocyanate terminated polymer in an amount from 6 to 46% by weight, bis-isocyanate terminated polymer in an amount from 54 to 14% by weight, and one or more components selected from the group consisting of: solvents, plasticizers, pigments, organic or inorganic fillers, adhesion promoter, UV-stabilizers, rheology modifiers, flame-retardant additives and other functional additives, the total sum of bis-isocyanate terminated polymer, tris-isocyanate terminated polymer, and the one or more selected component(s) being 100% by weight; with (b) 4,4′-methylene dianiline (MDA), at a temperature comprised from 10 to 150° C. and wherein the molar ratio between the amine and isocyanate reactive groups is from 1.0 to 1.5.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is from 20 to 50% by weight and the tris-isocyanate terminated polymer content is from 80 to 50%, with 4,4′-methylene dianiline (MDA) at a temperature comprised from 10 to 150° C. and wherein the molar ratio between the amine and isocyanate reactive groups is from 1.0 to 1.5.

In another embodiment of the second aspect of the invention, the process comprises reacting: (a) a mixture comprising bis-isocyanate terminated polymer in an amount from 18 to 45% by weight, tris-isocyanate terminated polymer in an amount from 72 to 45% by weight, and one or more components selected from the group consisting of: solvents, plasticizers, pigments, organic or inorganic fillers, adhesion promoter, UV-stabilizers, rheology modifiers, flame-retardant additives and other functional additives, the total sum of bis-isocyanate terminated polymer, tris-isocyanate terminated polymer, and the one or more selected component(s) being 100% by weight; with (b) 4,4′-methylene dianiline (MDA), at a temperature comprised from 10 to 150° C. and wherein the molar ratio between the amine and isocyanate reactive groups is from 1.0 to 1.5.

In another embodiment of the second aspect of the invention, the process comprises reacting: (a) a mixture comprising bis-isocyanate terminated polymer in an amount from 12 to 24% by weight, tris-isocyanate terminated polymer in an amount from 48 to 36% by weight, and one or more components selected from the group consisting of: solvents, plasticizers, pigments, organic or inorganic fillers, adhesion promoter, UV-stabilizers, rheology modifiers, flame-retardant additives and other functional additives, the total sum of bis-isocyanate terminated polymer, tris-isocyanate terminated polymer, and the one or more component(s) being 100% by weight; with (b) 4,4′-methylene dianiline (MDA), at a temperature comprised from 10 to 150° C. and wherein the molar ratio between the amine and isocyanate reactive groups is from 1.0 to 1.5.

In another embodiment of the second aspect of the invention, the process comprises reacting: (a) a mixture comprising bis-isocyanate terminated polymer in an amount from 6 to 12% by weight, tris-isocyanate terminated polymer in an amount from 24 to 18% by weight, and one or more components selected from the group consisting of: solvents, plasticizers, pigments, organic or inorganic fillers, adhesion promoter, UV-stabilizers, rheology modifiers, flame-retardant additives and other functional additives, the total sum of bis-isocyanate terminated polymer, tris-isocyanate terminated polymer, and the one or more selected component(s) being 100% by weight; with (b) 4,4′-methylene dianiline (MDA), at a temperature comprised from 10 to 150° C. and wherein the molar ratio between the amine and isocyanate reactive groups is from 1.0 to 1.5.

In another embodiment of the second aspect of the invention, the process comprises reacting a mixture consisting of tris-isocyanate terminated polymer and a bis-isocyanate terminated polymer, wherein the bis-isocyanate terminated polymer content in the mixture is 30% by weight and the tris-isocyanate terminated polymer content is from 70%, with 4,4′-methylene dianiline (MDA) at a temperature comprised from 10 to 150° C. and wherein the molar ratio between the amine and isocyanate reactive groups is from 1.0 to 1.5.

In another embodiment of the second aspect of the invention, the process comprises reacting: (a) a mixture comprising bis-isocyanate terminated polymer in an amount of 27% by weight, tris-isocyanate terminated polymer in an amount of 63% by weight, and one or more components selected from the group consisting of: solvents, plasticizers, pigments, organic or inorganic fillers, adhesion promoter, UV-stabilizers, rheology modifiers, flame-retardant additives and other functional additives, the total sum of bis-isocyanate terminated polymer, tris-isocyanate terminated polymer, and the one or more selected component(s) being 100% by weight; with (b) 4,4′-methylene dianiline (MDA), at a temperature comprised from 10 to 150° C. and wherein the molar ratio between the amine and isocyanate reactive groups is from 1.0 to 1.5.

In another embodiment of the second aspect of the invention, the process comprises reacting: (a) a mixture comprising bis-isocyanate terminated polymer in an amount of 18% by weight, tris-isocyanate terminated polymer in an amount of 42% by weight, and one or more components selected from the group consisting of: solvents, plasticizers, pigments, organic or inorganic fillers, adhesion promoter, UV-stabilizers, rheology modifiers, flame-retardant additives and other functional additives, the total sum of bis-isocyanate terminated polymer, tris-isocyanate terminated polymer, and the one or more selected component(s) being 100% by weight; with (b) 4,4′-methylene dianiline (MDA), at a temperature comprised from 10 to 150° C. and wherein the molar ratio between the amine and isocyanate reactive groups is from 1.0 to 1.5.

In another embodiment of the second aspect of the invention, the process comprises reacting: (a) a mixture comprising bis-isocyanate terminated polymer in an amount of 12% by weight, tris-isocyanate terminated polymer in an amount of 28% by weight, and one or more components selected from the group consisting of: solvents, plasticizers, pigments, organic or inorganic fillers, adhesion promoter, UV-stabilizers, rheology modifiers, flame-retardant additives and other functional additives, the total sum of bis-isocyanate terminated polymer, tris-isocyanate terminated polymer, and the one or more component(s) being 100% by weight; with (b) 4,4′-methylene dianiline (MDA), at a temperature comprised from 10 to 150° C. and wherein the molar ratio between the amine and isocyanate reactive groups is from 1.0 to 1.5.

Solvents, plasticizers, pigments, organic or inorganic fillers, adhesion promoter, UV-stabilizers, rheology modifiers, flame-retardant additives, are those used in the polymer manufacturing and are well-known for those skilled in the art. Reference is made, for instance, to Harper C. A., “Modern Plastics Handbook”, Chapter 4, 1999, pages 4.1-5.0; G. Wypych, “Handbook of Plasticizers”, Ed.: ChemTec Publishing, Chapter 11, 2004, pages 273-379; and Bolger M. et al. “Handbook for the chemical analysis of plastics and polymer additives”, Ed.: CRC Press, Chapters 3 to 9, 2008, pages 27-303.

In another embodiment of the second aspect of the invention, the process comprises reacting a primary amine functionalised polymer, with an aromatic compound of (X).

In another embodiment, the compound of formula (X) corresponds to one of formula (Xa):

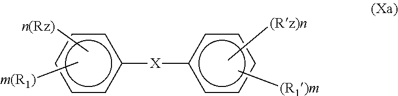

In another embodiment of the second aspect of the invention, the aromatic compound of formula (X) or (Xa) is one wherein n is 1.

In still another embodiment of the second aspect of the invention, the aromatic compound of formula (X) or (Xa) is one wherein n=1 and R_{z} and R_{z}′ are in para-position relative to X.

In still another embodiment of the second aspect of the invention, the aromatic compound of formula (X) or (Xa) is one wherein m is 4 and R₁, and R₁′ are H.

In still another embodiment of the second aspect of the invention, the aromatic compound of formula (X) is one wherein X is —CH₂—.

In still another embodiment, the aromatic compound of formula (X) is one of formula (Xa′):

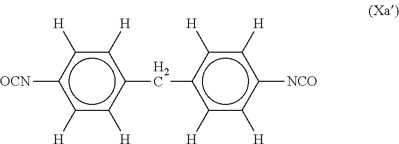

In another embodiment, the amine functionalised polymer is a tris- or a mixture of tris- and bis-amine terminated polymers.

These amine terminated polymers can be any commercially available or can be synthesized following well-known methods (Zhang L, et al., 2013; Fischer A., et al., 1999; Roundhill D. M., 1992).

In another embodiment of the second aspect of the invention, the process comprises reacting a mixture consisting of tris-amine terminated polymer and a bis-amine terminated polymer, wherein the bis-amine terminated polymer content in the mixture is from 20 to 70% by weight and the tris-amine terminated polymer content is from 80 to 30%, with 4,4′-methylene diphenyl diisocyanate (MDI) at a temperature comprised from −30 to 50° C. and wherein the molar ratio between the amine and isocyanate reactive groups is from 1.0 to 1.8.

In another embodiment of the second aspect of the invention, the process comprises reacting (a) a tris-amine terminated polymer, or a mixture comprising bis-amine terminated polymer in an amount from 18 to 63% by weight, tris-amine terminated polymer in an amount from 72 to 27% by weight, and one or more components selected from the group consisting of: solvents, plasticizers, pigments, organic or inorganic fillers, adhesion promoter, UV-stabilizers, rheology modifiers, flame-retardant additives or other functional additives, the total sum of bis-amine terminated polymer, tris-amine terminated polymer, and the one or more selected component(s) being 100% by weight; with (b) 4,4′-methylene diphenyl diisocyanate (MDI) at a temperature comprised from −30 to 50° C. and wherein the molar ratio between the amine and isocyanate is from 1.0 to 1.8.

In another embodiment of the second aspect of the invention, the process comprises reacting (a) a tris-amine terminated polymer, or a mixture comprising bis-amine terminated polymer in an amount from 12 to 42% by weight, tris-amine terminated polymer in an amount from 48 to 18% by weight, and one or more components selected from the group consisting of: solvents, plasticizers, pigments, organic or inorganic fillers, adhesion promoter, UV-stabilizers, rheology modifiers, flame-retardant additives and other functional additives, the total sum of bis-amine terminated polymer, tris-amine terminated polymer, and the one or more selected component(s) being 100% by weight; with (b) 4,4′-methylene diphenyl diisocyanate (MDI) at a temperature comprised from −30 to 50° C. and wherein the molar ratio between the amine and isocyanate is from 1.0 to 1.8.

In another embodiment of the second aspect of the invention, the process comprises reacting (a) a tris-amine terminated polymer, or a mixture comprising bis-amine terminated polymer in an amount from 8 to 28% by weight, tris-amine terminated polymer in an amount from 32 to 12% by weight, and one or more components selected from the group consisting of: solvents, plasticizers, pigments, organic or inorganic fillers, adhesion promoter, UV-stabilizers, rheology modifiers, flame-retardant additives and other functional additives, the total sum of bis-amine terminated polymer, tris-amine terminated polymer, and the one or more selected component(s) being 100% by weight; with (b) 4,4′-methylene diphenyl diisocyanate (MDI) at a temperature comprised from −30 to 50° C. and wherein the molar ratio between the amine and isocyanate is from 1.0 to 1.8.

In another embodiment of the second aspect of the invention, the process comprises reacting a mixture consisting of tris-amine terminated polymer and a bis-amine terminated polymer, wherein the bis-amine terminated polymer content in the mixture is 30% by weight and the tris-amine terminated polymer content is 70%, with 4,4′-methylene diphenyl diisocyanate (MDI) at a temperature comprised from −30 to 50° C. and wherein the molar ratio between the amine and isocyanate reactive groups is from 1.0 to 1.5.

In another embodiment of the second aspect of the invention, the process comprises reacting (a) a tris-amine terminated polymer, or a mixture comprising bis-amine terminated polymer in an amount of 27% by weight, tris-amine terminated polymer in an amount of 63% by weight, and one or more components selected from the group consisting of: solvents, plasticizers, pigments, organic or inorganic fillers, adhesion promoter, UV-stabilizers, rheology modifiers, flame-retardant additives and other functional additives, the total sum of bis-amine terminated polymer, tris-amine terminated polymer, and the one or more selected component(s) being 100% by weight; with (b) 4,4′-methylene diphenyl diisocyanate (MDI) at a temperature comprised from −30 to 50° C. and wherein the molar ratio between the amine and isocyanate is from 1.0 to 1.5.

In another embodiment of the second aspect of the invention, the process comprises reacting (a) a tris-amine terminated polymer, or a mixture comprising bis-amine terminated polymer in an amount of 18% by weight, tris-amine terminated polymer in an amount of 42% by weight, and one or more components selected from the group consisting of: solvents, plasticizers, pigments, organic or inorganic fillers, adhesion promoter, UV-stabilizers, rheology modifiers, flame-retardant additives and other functional additives, the total sum of bis-amine terminated polymer, tris-amine terminated polymer, and the one or more selected component(s) being 100% by weight; with (b) 4,4′-methylene diphenyl diisocyanate (MDI) at a temperature comprised from −30 to 50° C. and wherein the molar ratio between the amine and isocyanate is from 1.0 to 1.5.

In another embodiment of the second aspect of the invention, the process comprises reacting (a) a tris-amine terminated polymer, or a mixture comprising bis-amine terminated polymer in an amount of 12% by weight, tris-amine terminated polymer in an amount of 28% by weight, and one or more components selected from the group consisting of: solvents, plasticizers, pigments, organic or inorganic fillers, adhesion promoter, UV-stabilizers, rheology modifiers, flame-retardant additives and other functional additives, the total sum of bis-amine terminated polymer, tris-amine terminated polymer, and the one or more selected component(s) being 100% by weight; with (b) 4,4′-methylene diphenyl diisocyanate (MDI) at a temperature comprised from −30 to 50° C. and wherein the molar ratio between the amine and isocyanate is from 1.0 to 1.5.

Also, as it has been stated above, the invention provides in a third aspect a self-healing, reprocessable and recyclable polymer obtainable by the process of the second aspect of the invention.

In one embodiment of the third aspect of the invention, the polymer is obtainable by carrying out the process of the second aspect of the invention in a molar ratio amine:isocyanate comprised from 1.2 to 1.8. In another embodiment, the polymer is obtainable by carrying out the process of the second aspect of the invention in a molar ratio amine:isocyanate comprised from 1.3 to 1.8.

It has been found, when the process of the second aspect of the invention is performed under the specific molar ratio 1.2-1.8, that the resulting polymer comprises units of formula (I), as defined above, but also a second type of units (units (Ibis)), being comprised the molar ratio between the units of formula (I) and the units of formula (Ibis) from 1.0:0.2 to 1.0:0.8. These units of formula (Ibis) uniquely differ from the units of formula (I) in the replacement of a radical —[P—NR₂—CO—NR₃]ₙ—, present in the unit of formula (I), by a —NH₂ radical:

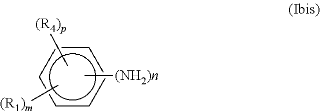

wherein:

R₁, R₄, n, m, and p are as defined above for unit of formula (I). In view of the definition of (I) and (Ibis) it is clear that R₁, R₄, n, m, and p, must have the same meaning/value in both units. Therefore, when there are provided specific embodiments of polymers comprising units of formula (I) and (Ibis), the specific fallback positions for radicals in (I) will also apply to the radicals of units (Ibis). The same reasoning applies when the molar ratio amine:isocyanate of the process of the second aspect of the invention is from 1.3 to 1.8, the polymer of the invention comprises units of formula (I) and (Ibis) in a molar ratio comprised from 1.0:0.3 to 1.0:0.8.

Therefore, the above product-by-process embodiment providing the polymer of the invention by carrying out the process of the second aspect of the invention in a molar ratio amine:isocyanate comprised from 1.2 to 1.8, can be alternatively defined as a self-healing, recyclable and reprocessable polymer comprising units of formula (I) and units of formula (Ibis) as defined above, being the molar ratio between (I) and (Ibis) comprised from 1.0:0.2 to 1.0:0.8. In another embodiment, the above product-by-process embodiment providing the polymer of the invention by carrying out the process of the second aspect of the invention in a molar ratio amine:isocyanate comprised from 1.3 to 1.8, can be alternatively defined as a self-healing, recyclable and reprocessable polymer comprising units of formula (I) and units of formula (Ibis) as defined above, being the molar ratio between (I) and (Ibis) comprised from 1.0:0.3 to 1.0:0.8

The present inventors have found that when the polymer comprises units of formula (I) and (Ibis) (which is indicative that the process for its preparation has used a molar ratio amine:isocyanate comprised from 1.2 to 1.8) the self-healing properties of the polymer are surprisingly better than outside this range. As it is shown in Table 1 below, a self-healed film made of a polymer obtainable using an amine:isocyanate molar ratio of 1.3 (which means that the end polymer comprises units of formula (I) and (Ibis) in a molar ratio 1.0:0.3) has a tensile strength value of at least two-fold the value shown by a film made of a polymer which has been obtained using an amine:isocyanate molar ratio of 1.1. These data, therefore, supports the fact that the inclusion of such units of formula (Ibis) in the polymer of the first aspect of the invention improves the mechanical properties of the self-healed polymer.

Another remarkable finding from the results of Table 1 is that it is the first time that it is reported a self-healed aromatic urea polymer with a value of tensile strength above 2.0 MPa. This important improvement in the behavior of the polymer is due to the nature of the aromatic units of formula (I) disclosed in the present application but also it is due to the inclusion of the units of formula (Ibis), due to the specific molar ratio between the amine polymer and the isocyanate polymer used in the process for its preparation. The fact that the self-healed polymer of the invention shows such value of tensile strength (above 2 MPa) means prolonging the life of the polymer.

In view of the above, in one embodiment the present invention provides a self-healing, reprocessable and recyclable crosslinked polymer comprising units of formula (I) and (Ibis)

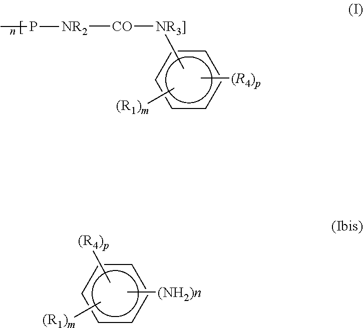

wherein the molar ratio between the units of formula (I) and the units of formula (Ibis) being comprised from 1.0:0.2 to 1.0:0.8; and wherein

R₄ are radicals independently selected from the group consisting of radicals of formula (II), (III), and (IV):

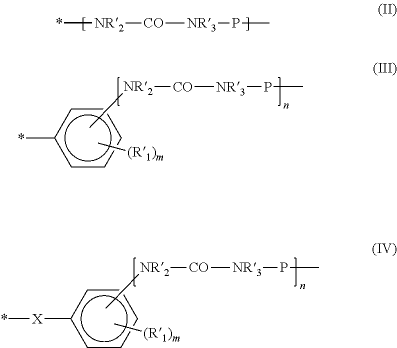

R₁ and R₁′ are radicals independently selected from the group consisting of:

—H, (C₁-C₂₀)alkyl, C₅-C₁₄)aryl, —OR₅,—(CO)R_{6,} —O(CO)R_{7,} —(SO)R_{8,} —NH—CO—R₉, —COOR₁₀, —NR₁₁R₁₂, —NO₂, and halogen;

R₂, R₂′, R₃, and R₃′ are —H;

P is a polymeric chain, *denotes the position through which radical R₄ binds to the phenyl ring of the unit of formula (I),

X is a biradical selected from the group consisting of: —CH₂—, —O—, —NH—, —S—, —CO—, —S(O₂)—, —Si(R₁₃R₁₄)—;

R₅ to R₁₂ are radicals independently selected from the group consisting of: —H, (C₁-C20)alkyl, and C₅-C14)aryl,

R₁₃ and R₁₄ are radicals independently selected from the group consisting of (C₁-C₅)alkyl, and (C₅-C₁₄)aryl,

(C₅-C₁₄)aryl radical represents a ring system with 1-3 rings which comprises from 5 to 14 carbon atoms, the rings being saturated, partially unsaturated, or aromatic; and being fused, partially fused or isolated; being at least one of the rings an aromatic ring; and the ring system being optionally substituted by one or more radicals independently selected from the group consisting of (C₁-C₆)alkyl, (C₁-C₆)haloalkyl, (C₁-C₆)alkoxy, nitro, cyano, and halogen;

p is from 1 to 2;

m is from 3 to 4; and

n is from 1 to 2; provided that n+m+p is 6;

the polymer comprising from 5 to 25 weight % of urea moieties, and having H-bonding and pi-pi staking interactions between the urea groups, and a tensile strength comprised from 3 to 15 MPa; and

the tensile strength being measured following determined UNE-EN-ISO 527 standard, which comprises the stretching of dumbbell-shaped specimens of normalized dimensions at an elongation rate of 500 mm min^{-1,} and measuring the value of stress (MPa) until the specimen is broken.

In another embodiment the present invention provides a self-healing, reprocessable and recyclable crosslinked polymer comprising units of formula

(I) and (Ibis)

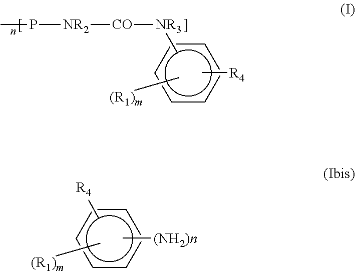

wherein the molar ratio between the units of formula (I) and the units of formula (Ibis) being comprised from 1.0:0.2 to 1.0:0.8; and

wherein

R₄ are radicals independently selected from the group consisting of radicals of formula (II), (III), and (IV):

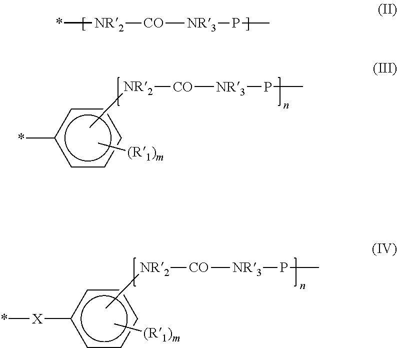

R₁ and R₁′ are radicals independently selected from the group consisting of: —H, (C₁-C₂₀)alkyl, C₅-C₁₄)aryl, —OR₅,—(CO)R_{6,} —O(CO)R_{7,} —(SO)R_{8,} —NH—CO—R₉, —COOR₁₀, —NR₁₁R₁₂, —NO₂, and halogen;

R₂, R₂′, R₃, and R₃′ are —H;

P is a polymeric chain,

*denotes the position through which radical R₄ binds to the phenyl ring of the unit of formula (I),

X is a biradical selected from the group consisting of: —CH₂—, —O—, —NH—, —S—, —CO—, —S(O₂)—, —Si(R₁₃R₁₄)—;

R₅ to R₁₂ are radicals independently selected from the group consisting of: —H, (C₁-C₂₀))alkyl, and C₅-C₁₄)aryl;

R₁₃ and R₁₄ are radicals independently selected from the group consisting of (C₁-C₅)alkyl, and (C₅-C₁₄)aryl;

(C₅-C₁₄)aryl radical represents a ring system with 1-3 rings which comprises from 5 to 14 carbon atoms, the rings being saturated, partially unsaturated, or aromatic; and being fused, partially fused or isolated; being at least one of the rings an aromatic ring; and the ring system being optionally substituted by one or more radicals independently selected from the group consisting of (C₁-C₆)alkyl, (C₁-C₆)haloalkyl, (C₁-C₆)alkoxy, nitro, cyano, and halogen;

m is from 3 to 4; and

n is from 1 to 2; provided that n+m is 5;

the polymer comprising from 5 to 25 weight % of urea moieties, and having H-bonding and pi-pi staking interactions between the urea groups, and a tensile strength comprised from 3 to 15 MPa; and

the tensile strength being measured following determined UNE-EN-ISO 527 standard, which comprises the stretching of dumbbell-shaped specimens of normalized dimensions at an elongation rate of 500 mm min^{-1,} and measuring the value of stress (MPa) until the specimen is broken;

In another embodiment, the self-healing, reprocessable and recyclable polymer comprises units of formula (I) and of formula (Ibis) in a molar ratio comprised from 1.0:0.2 to 1.0:0.8, as defined above, being the units of formula (I) those corresponding to formula (V)

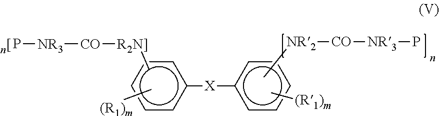

wherein R₁, R₁′, R₂, R₂′, R₃, R₃′, X, m, and n are as defined above. In view of the above explanations, it is clear that this embodiment also discloses implicitly the unit (Ibis) which will have exactly the same structure as (V) but just differing in the replacement of one of —[P—NR₂—CO—NR₃]ₙ— radicals by one —NH₂:

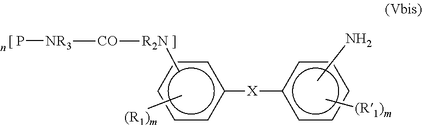

In another embodiment, the self-healing, reprocessable and recyclable polymer comprises units of formula (I) and of formula (Ibis), as defined above, in a molar ratio comprised from 1.0:0.2 to 1.0:0.8, wherein n is 1 and, in the case of the unit of formula (I), the urea birradicals are in para-position relative to the X biradical.

In another embodiment, the self-healing, reprocessable and recyclable polymer comprises units of formula (I) and of formula (Ibis), as defined above, in a molar ratio comprised from 1.0:0.2 to 1.0:0.8, wherein R₁, R₁′, R₂, R₂′, R₃ and R₃′ are —H.

In another embodiment, the self-healing, reprocessable and recyclable polymer comprises units of formula (I) and of formula (Ibis), as defined above, in a molar ratio comprised from 1.0:0.2 to 1.0:0.8, wherein m is 4 and R₁, R₁′, R₂, R₂′, R₃ and R₃′ are —H.

In another embodiment, the self-healing, reprocessable and recyclable polymer comprises units of formula (I) and of formula (Ibis), as defined above, in a molar ratio comprised from 1.0:0.2 to 1.0:0.8, wherein the unit of formula (I) corresponds to

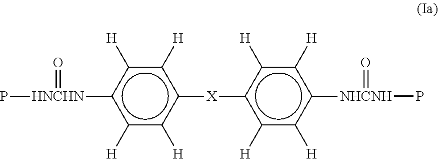

wherein P means a polyurethane polymer, and X is as defined above. This embodiment implicitly discloses the structure of the unit (Ibis), which will differ from (I) in the replacement of the P—NHC(=O)NH— by —NH₂:

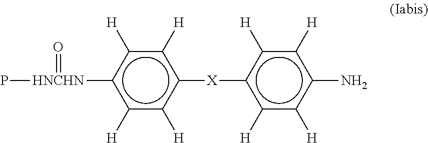

In another embodiment, the self-healing, reprocessable and recyclable polymer comprises units of formula (I) and of formula (Ibis), as defined above, in a molar ratio comprised from 1.0:0.2 to 1.0:0.8, wherein the unit of formula (I) corresponds to

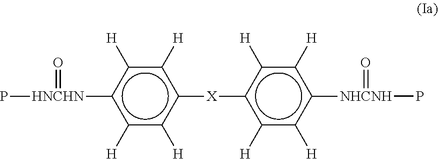

wherein P means a polyurethane polymer. This embodiment implicitly discloses the structure of the unit (Ibis), which will differ from (I) in the replacement of the P—NHC(=O)NH— by —NH₂

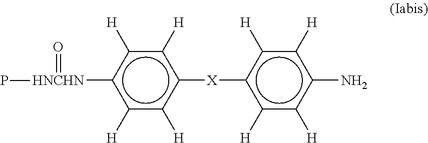

In another embodiment, the self-healing, reprocessable and recyclable polymer comprises units of formula (I) and of formula (Ibis), as defined above, in a molar ratio comprised from 1.0:0.2 to 1.0:0.8, wherein the unit of formula (I) corresponds to (Ia′):

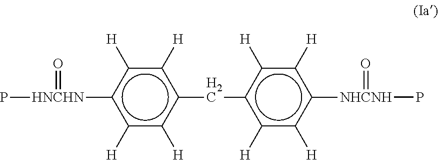

wherein P means a polyurethane polymer. This embodiment implicitly discloses the structure of the unit (Ibis), which will differ from (I) in the replacement of the P—NHC(=O)NH— by —NH₂:

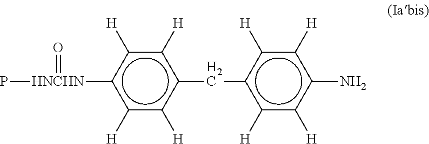

The above embodiments concerning a polymer comprising units of formula (I) and (Ibis) in a molar ratio comprised from 1.0:0.2 to 1.0:0.8 also applies to the polymer comprising the same units in a molar ratio 1.0:0.3 to 1.0:0.8.

In a fourth aspect, the present invention provides a process for recycling the polymer of the first aspect of the invention by applying heat and pressure.

In one embodiment of the process of the fourth aspect, the present invention provides a process for recycling a self-healing, reprocessable and recyclable crosslinked polymer comprising units of formula (I)

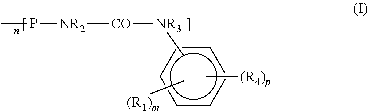

wherein

R₄ are radicals independently selected from the group consisting of radicals of formula (II), (III), and (IV):

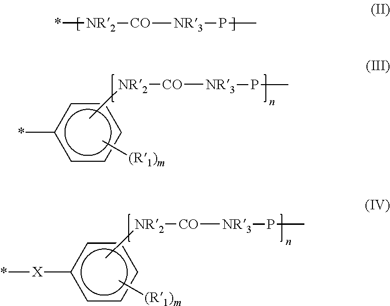

R₁ and R₁′ are radicals independently selected from the group consisting of: —H, (C₁-C₂₀))alkyl, C₅-C₁₄)aryl, —OR₅,—(CO)R_{6,} —O(CO)R_{7,} —(SO)R_{8,} —NH—CO—R₉, —COOR₁₀, —NR₁₁R₁₂, —NO₂, and halogen;

R₂, R₂′, R₃, and R₃′ are —H;

P is a polymeric chain, *denotes the position through which radical R₄ binds to the phenyl ring of the unit of formula (I),

X is a biradical selected from the group consisting of: —CH₂—, —O—, —NH—, —S—, —CO—, —S(O₂)—, —Si(R₁₃R₁₄)—;

R₅ to R₁₂ are radicals independently selected from the group consisting of: —H, (C₁-C₂₀)alkyl, and C₅-C₁₄)aryl;

R₁₃ and R₁₄ are radicals independently selected from the group consisting of (C₁-C₅)alkyl, and (C₅-C₁₄)aryl;

(C₅-C₁₄)aryl radical represents a ring system with 1-3 rings which comprises from 5 to 14 carbon atoms, the rings being saturated, partially unsaturated, or aromatic; and being fused, partially fused or isolated; being at least one of the rings an aromatic ring; and the ring system being optionally substituted by one or more radicals independently selected from the group consisting of (C₁-C₆)alkyl, (C₁-C₆)haloalkyl, (C₁-C₆)alkoxy, nitro, cyano, and halogen;

p is from 1 to 2;

m is from 3 to 4; and

n is from 1 to 2; provided that p+n+m is 6;

the polymer comprising from 5 to 25 weight % of urea moieties, and having H-bonding and pi-pi staking interactions between the urea groups, and a tensile strength comprised from 3 to 15 MPa, the process comprising the step of applying pressure and heat to the polymer; and

the tensile strength being measured following determined UNE-EN-ISO 527 standard, which comprises the stretching of dumbbell-shaped specimens of normalized dimensions at an elongation rate of 500 mm min^{-1,} and measuring the value of stress (MPa) until the specimen is broken.

In another embodiment of the fourth aspect, the present invention provides a process for recycling a self-healing, reprocessable and recyclable crosslinked polymer comprising units of formula (I)

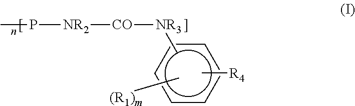

wherein

R₄ are radicals independently selected from the group consisting of radicals of formula (II), (Ill), and (IV):

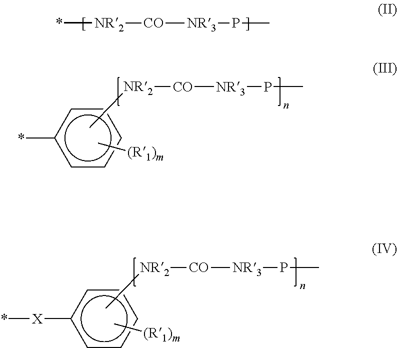

R₁ and R₁′ are radicals independently selected from the group consisting of: —H, (C₁-C₂₀)alkyl, C₅-C₁₄)aryl, —OR₅,—(CO)R_{6,} —O(CO)R_{7,} —(SO)R_{8,} —NH—CO—R₉, —COOR₁₀, —NR₁₁R₁₂, —NO₂, and halogen;

R₂, R₂′, R₃, and R₃′ are —H;

P is a polymeric chain,

*denotes the position through which radical R₄ binds to the phenyl ring of the unit of formula (I),

X is a biradical selected from the group consisting of: —CH₂—, —O—, —NH—, —S—, —CO—, —S(O₂)—, —Si(R₁₃R₁₄)—;

R₅ to R₁₂ are radicals independently selected from the group consisting of: —H, (C₁-C20)alkyl, and C₅-C₁₄)aryl;

R₁₃ and R₁₄ are radicals independently selected from the group consisting of (C₁-C₅)alkyl, and (C₅-C₁₄)aryl;

(C₅-C₁₄)aryl radical represents a ring system with 1-3 rings which comprises from 5 to 14 carbon atoms, the rings being saturated, partially unsaturated, or aromatic; and being fused, partially fused or isolated; being at least one of the rings an aromatic ring; and the ring system being optionally substituted by one or more radicals independently selected from the group consisting of (C₁-C₆)alkyl, (C₁-C₆)haloalkyl, (C₁-C₆)alkoxy, nitro, cyano, and halogen;

m is from 3 to 4; and

n is from 1 to 2; provided that n+m is 5;

the polymer comprising from 5 to 25 weight % of urea moieties, and having H-bonding and pi-pi staking interactions between the urea groups, and a tensile strength comprised from 3 to 15 MPa, the process comprising the step of applying pressure and heat to the polymer; and

the tensile strength being measured following determined UNE-EN-ISO 527 standard which comprises the stretching of dumbbell-shaped specimens of normalized dimensions at an elongation rate of 500 mm min^{-1,} and measuring the value of stress (MPa) until the specimen is broken.

In one embodiment of the process of the fourth aspect of the invention, the polymer is grinded previous to the step of heat and pressure. In such case, the material can be milled in a cutting mill (Pulverisette) after being freezed in liquid nitrogen. The grinded material is then placed in a mould and pressed at high temperature by means of a hot press. Alternatively, the material can be recycled by hot pressing from a component of a given geometry to a different geometry and shape.

In one embodiment of the process of the fourth aspect of the invention, the temperature is comprised from 140 to 250° C. In another embodiment the temperature is 160° C.

In another embodiment of the process of the fourth aspect of the invention, the pressure is comprised from 20 to 100 bar. In another embodiment the pressure is 50 bar.

Furthermore, the present invention covers all possible combinations of particular and preferred groups described hereinabove.

In another aspect, the present invention provides an article manufactured with the self-healing, reprocessable and recyclable polymer of the first aspect of the invention.

In one embodiment, the article is prepared following the RIM technique. R.I.M. (Reaction Injection Molding) is a technique to produce plastic parts by low-pressure injection of resins in molds. Different types of molds are applicable, among which resin molds are the most frequently used. Different molds can be used, depending on trade off series, size of the part and speed. In one embodiment, the article is prepared formulating the polymer as a two-component reactive system wherein one of the components is based on an isocyanate- or amine-functionalised polymer and the second component is a crosslinker based on an aromatic compound with amine or isocyanate functionality, respectively. Prior to application, the two components have to be mixed and well homogenized, and then the mixture is injected in the RIM process. After the application, the system must be allowed to cure in order to obtain a solid material.

In a fourth aspect the present invention provides the use of the polymer composition of the first aspect of the invention as an adhesive. In this aspect, the polymer composition of the first aspect of the invention can be formulated as a two-component reactive system, wherein one of the components is based on an isocyanate- or amine-functionalised polymer and the second component is a crosslinker based on an aromatic compound with amine or isocyanate functionality, respectively. Prior to application, the two components have to be mixed and well homogenized, and then the mixture is applied as an adhesive. After the application, the system must be allowed to cure in order to become solid and to perform its adhesive properties.

In another aspect, the present invention provides the use of the polymer composition as defined in the first aspect of the invention as construction sealant. In this aspect, the polymer composition of the first aspect of the invention can be formulated as a two-component reactive system wherein one of the components is based on an isocyanate- or amine-functionalised polymer and the second component is a crosslinker based on an aromatic compound with amine or isocyanate functionality, respectively. Prior to application, the two components have to be mixed and well homogenized, and then the mixture is applied as a sealant. After the application, the system must be allowed to cure in order to obtain an elastomeric solid able to perform its sealing properties.

Due to the properties shown, the polymer of the invention can be used as a self-healing, recyclable and reprocessable material for the manufacturing of: (a) binding material for the manufacturing of anti-vibration mats for the railway sector; (b) rubber watchstrap for watches; (c) self-healing elastic bands; (d) self-healing septums, to store unstable and/or dangerous liquids; (d) extendable hoses without the need for unions; (e) certain layers in the interior of tires; (f) self-healing flexible screens; (g) self-healing polyurethane foam; (h) paint in powder; (i) self-healing joints for the aerospace industry; (j) adhesives for hybrid joints or not, in the transport sector (railway, . . . ; (k) interior surfaces in automobiles; (I) coverings for roofs, walls, floors, home appliances; (m) automotive parts etc.

### EXAMPLES

1. Materials and Methods

Poly(propylene glycol)s (PPG) of formula (XIV) (Mₙ 6 and Mₙ 4 kDa), and of formula (XV) (Mₙ2 and Mₙ1 kDa) were obtained from Bayer Materials Science. Isophorone diisocyanate (IPDI, 98%), dibutyltin dilaurate (DBTDL, 95%), 4,4′-methylenedianiline (MDA) (VIa′) (>95%) and tetrahydrofurane (THF) were purchased from Sigma-Aldrich and were used as received.

Fourier transform infrared (FTIR) spectra were registered in a Jasco FT/IR 4100 spectrophotometer, using Gladi ATR accessory and collecting 32 scans at a resolution of 4 cm⁻¹. Mechanical testing was performed using INSTRON 3365 Long travel Elastomeric Extensometer controlled by Bluehill Lite software. Tensile strength and elongation at break measurements were carried out according to UNE-EN-ISO 527 standard using dumbbell type test specimens and an elongation rate of 500 mm⁻¹.

### Example 1

### Synthesis of tris-isocyanate-terminated polyurethane PU1 (Mₙ 6,6 kDa)

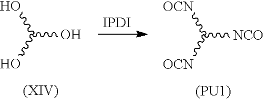

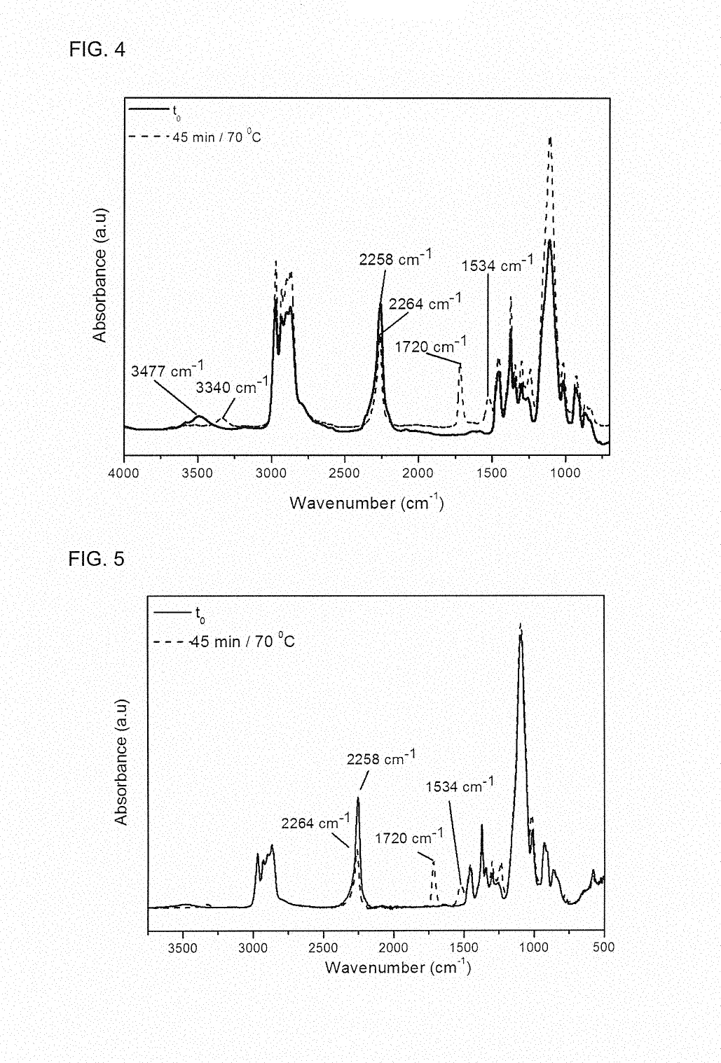

A mixture of poly(propylene glycol) of formula (XIV) (Mₙ 6 kDa) (390 g, 65 mmol) and isophorone diisocyanate (IPDI) (45.45 g, 204.5 mmol) were fed into a 1 L glass reactor equipped with mechanical stirrer and a vacuum inlet. The mixture was degassed by stirring under vacuum while heating at 70° C. for 10 min. Then dibutyltin dilaurate (DBTDL) (50 ppm) was added and the mixture was further stirred under vacuum at 70° C. for 45 minutes. The reaction was monitored by FTIR spectroscopy (FIG. 4). The resulting tris-isocyanate terminated polymer PU1 (Mₙ6,6 kDa) was obtained in the form of a colorless liquid and stored in a tightly closed glass bottle. Yield: 398 g, 92%.

### Example 2

### Synthesis of tris-isocyanate-terminated polyurethane PU2 (Mₙ 46, 6 kDa)

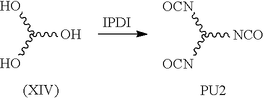

A mixture of poly(propylene glycol) of formula (XIV) (Mₙ 4 kDa) (390 g, 97.5 mmol) and isophorone diisocyanate (IPDI) (68.18 g, 307 mmol) were fed into a 1 L glass reactor equipped with mechanical stirrer and a vacuum inlet. The mixture was degassed by stirring under vacuum while heating at 70° C. for 10 min. Then dibutyltin dilaurate (DBTDL) (50 ppm) was added and the mixture was further stirred under vacuum at 70° C. for 45 minutes. The reaction was monitored by FTIR spectroscopy (FIG. 5). The resulting tris-isocyanate terminated polymer PU2 (Mₙ 4,6 kDa) was obtained in the form of a colorless liquid and stored in a tightly closed glass bottle. Yield: 435 g, 95%.

### Example 3

### Synthesis of bis-isocyanate-terminated polyurethane PU3 (Mₙ 2,4 kDa)

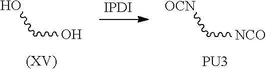

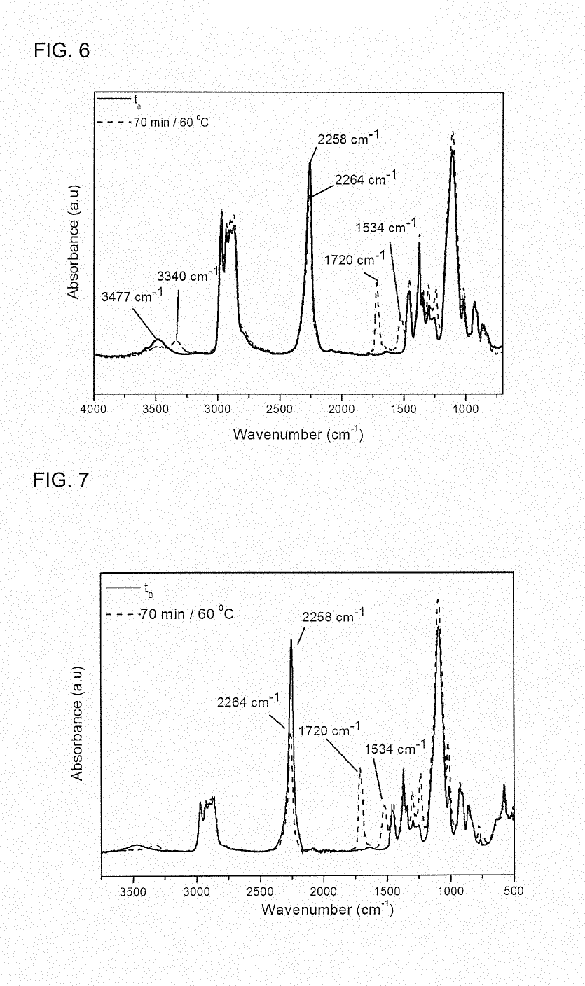

A mixture of poly(propylene glycol) of formula (XV) (Mₙ 2 kDa) (250 g, 125 mmol) and IPDI (55.5 g, 250 mmol) were fed into a 1 L glass reactor equipped with mechanical stirrer and a vacuum inlet. The mixture was degassed by stirring under vacuum while heating at 60° C. for 10 min. Then DBTDL (50 ppm) was added and the mixture was further stirred under vacuum at 60° C. for 70 minutes. The reaction was monitored by FTIR spectroscopy (FIG. 6). The resulting bis-isocyanate terminated polymer PU3 (Mₙ 2,4 kDa) was obtained in the form of a colorless liquid and stored in a tightly closed glass bottle. Yield: 301 g, 98%.

### Example 4

### Synthesis of bis-isocyanate-terminated polyurethane PU4 (Mₙ 1,4 kDa)

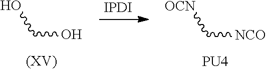

A mixture of poly(propylene glycol) of formula (XV) (Mₙ 1 kDa) (250 g, 250 mmol) and IPDI (111 g, 500 mmol) were fed into a 1 L glass reactor equipped with mechanical stirrer and a vacuum inlet. The mixture was degassed by stirring under vacuum while heating at 60° C. for 10 min. Then DBTDL (50 ppm) was added and the mixture was further stirred under vacuum at 60° C. for 70 minutes. The reaction was monitored by FTIR spectroscopy (FIG. 7). The resulting bis-isocyanate terminated polymer PU4 (Mₙ 1,4 kDa) was obtained in the form of a colorless liquid and stored in a tightly closed glass bottle. Yield: 350 g, 97%.

### Example 5

### Synthesis of Self-Healing and Recyclable Poly(Urea-Urethane) PUU1

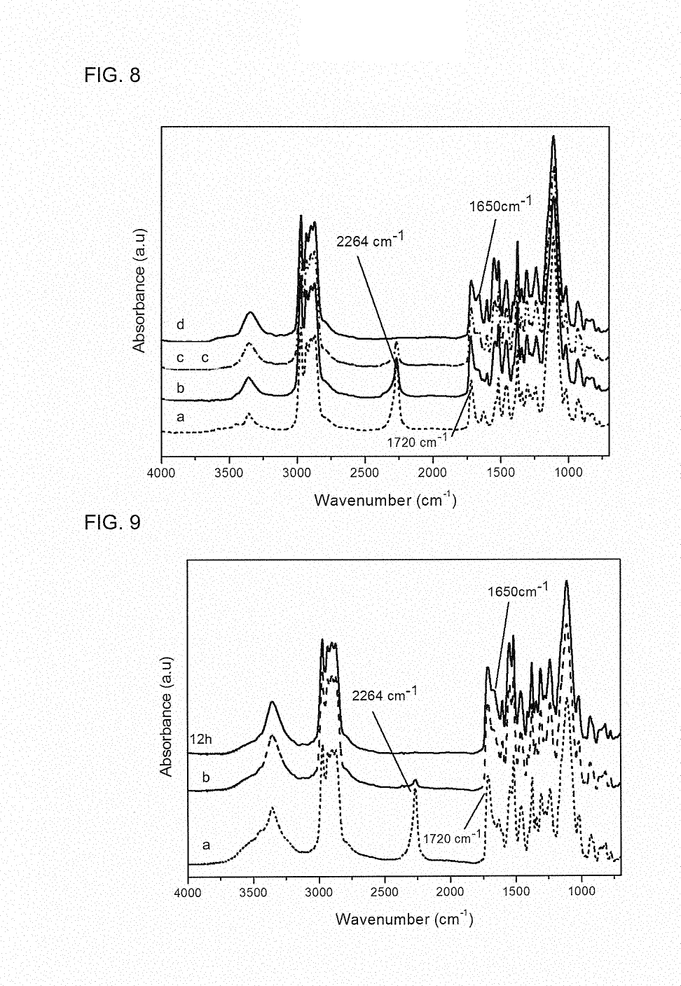

Isocyanate-terminated polyurethane polymers PU2 (Mₙ 4,6 kDa) (20 g) and PU4 (Mₙ 1,4 kDa) (30 g) were mixed in a 250 mL glass reactor. Then, a solution of MDA (VIa′) (7.06 g, 1.3 equivalents of amine with respect to NCO groups) in THF (5 mL) was added. The mixture was degassed under vacuum for 15 minutes and the mixture was placed on to an open mold. The curing was allowed to proceed for 16 h at 70° C. and was monitored by FTIR spectroscopy (FIG. 8). Poly(urea-urethane) PUU1 was obtained as a clear transparent elastomeric material. Yield: 49.6 g, 89%.

### Example 6

### Synthesis of Self-Healing and Recyclable Poly(Urea-Urethane) PUU2

Isocyanate-terminated polyurethane polymers PU2 (Mₙ 4,6 kDa) (20 g) and PU3 (Mₙ 2,4 kDa) (30 g) and IPDI (4.17 g) were mixed in a 250 mL glass reactor. Then, a solution of MDA (VI'a) (9.68 g, 1.3 equivalents of amine with respect to NCO groups) in THF (6 mL) was added. The mixture was degassed under vacuum for 15 minutes and the mixture was placed on to an open mold. The curing was allowed to proceed for 16 h at 70° C. and was monitored by FTIR spectroscopy (FIG. 9). Poly(urea-urethane) PUU2 was obtained as a clear transparent elastomeric material. Yield: 54.3 g, 91%.

### Example 7

### Synthesis of Self-Healing and Recyclable Poly(Urea-Urethane) PUU3

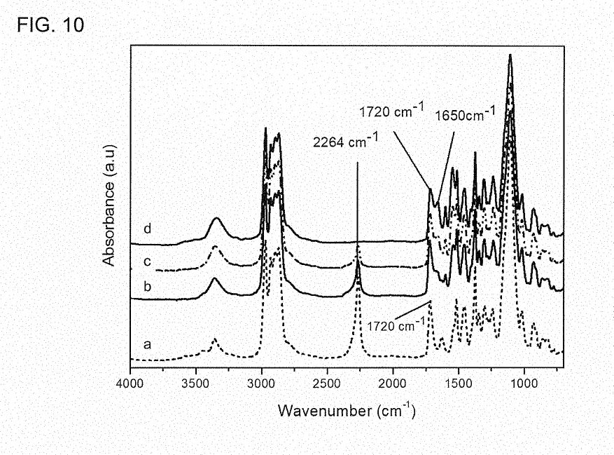

Isocyanate-terminated polyurethane polymers PU1 (Mₙ 6,6 kDa) (35 g) and PU3 (Mₙ 2,4 kDa) (15 g) were mixed in a 250 mL glass reactor. Then, a solution of MDA (VIa′) (3.21 g, 1.1 equivalents of amine with respect to NCO groups) in THF (2.5 mL) was added. The mixture was degassed under vacuum for 15 minutes and the mixture was placed on to an open mold. The curing was allowed to proceed for 16 h at 70° C. and was monitored by FTIR spectroscopy (FIG. 10). Poly(urea-urethane) PUU3 was obtained as a clear transparent elastomeric material. Yield: 46.3 g, 87%.

### Example 8

### Characterization of Self-Healing Efficiency through Measurement of Tensile Strength and Elongation at Break

A 2 mm thick film of the poly(urea-urethane) elastomers PUU1, PUU2 and PUU3 were prepared following the preparation methods described in Examples 5, 6 and 7, respectively, and placing the reactive mixture in a 2 mm thick square mold. The curing was allowed to proceed for 16 h at 70° C. and the solid films were then cut in the form of dumbbell-shaped specimens, in order to perform tensile strength measurements. Some of the specimens were mechanically tested as pristine samples. The rest of them were tested after being cut in half and then mended by simple contact at room-temperature for 1 hour. Tensile strength tests were performed according to ISO 527 and stress vs. elongation curves were monitored. Briefly, dumbbell-shaped specimens of normalized dimensions are stretched at an elongation rate of 500 mm min^{-l}and the values of stress (MPa) and elongation (%) are monitored until the specimen is broken. The results are summarized in Table 1.

TABLE 1

| | | | Self- | | |
|---|---|---|---|---|---|
| | Pristine | | healed | | Self- |
| | tensile | Pristine | tensile | Self-healed | healing |
| | strength | elongation | strength | elongation | recovery |
| Sample | (MPa) | at break (%) | (MPa) | at break (%) | (%) |
| PUU1 | 4.2 | 950 | 3.5 | 800 | 83 |
| (Example 5) | | | | | |
| PUU2 | 9.1 | 970 | 2.3 | 100 | 25 |
| (Example 6) | | | | | |
| PUU3 | 6.1 | 1350 | 1.1 | 200 | 18 |
| (Example 7) | | | | | |

### Example 9

### Recovery of Tensile Strength and Elongation at Break after Recycling

In order to measure the recovery of the mechanical properties of the different PUU samples after the recycling process, PUU1, PUU2 and PUU3 were prepared following the preparation methods described in Examples 5, 6 and 7, respectively, and then they were grinded to powder in a cutting mill. Then, the materials in the form of powder were reprocessed in a hot-press at 160° C. and 50 bar for 1 hour using a 2 mm thick square mold. Homogeneous solid films were obtained in all cases. The solid films were then cut in the form of dumbbell-shaped specimens, in order to perform tensile strength measurements. Tensile strength tests were performed according to ISO 527 and stress vs. elongation curves were monitored in the same way as described in Example 8. The results are summarized in Table 2.

TABLE 2

| | Pristine | | Recycled | Recycled | |
|---|---|---|---|---|---|
| | tensile | Pristine | tensile | elongation | |
| | strength | elongation | strength | at | Recovery |
| Sample | (MPa) | at break (%) | (MPa) | break (%) | (%) |
| PUU1 | 4.2 | 950 | 4.5 | 1000 | 107 |
| (Example 5) | | | | | |
| PUU2 | 9.1 | 970 | 9.2 | 1050 | 101 |
| (Example 6) | | | | | |
| PUU3 | 6.1 | 1350 | 6.8 | 1320 | 111 |
| (Example 7) | | | | | |

### Example 10

### Mechanical Properties of a Polymer of the Invention vs. Other Known in the State of the Art

TABLE 3

| | | Tensile strength | Self-healed |
|---|---|---|---|
| | | after self-healing | elongation |
| Sample | | (r.t.) (MPa) | at break (%) |
| 1 | 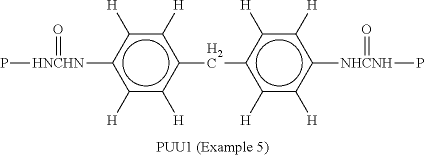 | 3.5 | 800 |
| 2 | 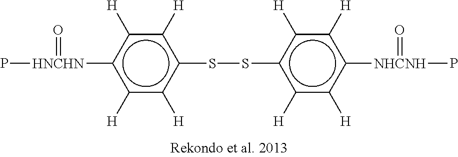 | 0.78 | 3015 |
| 3 | REVERLINK SH | 2 | 250 |
| | (Arkema) | | |
| 4 | REVERLINK HR | 2.5 | 350 |

(Arkema)

Sample 1: it was prepared and tested according to the procedure described in example 8.

Sample 2: A 2 mm thick film of the poly(urea-urethane) of formula

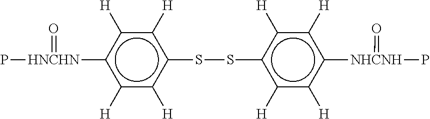

was prepared as described by Rekondo A. et. al (Rekondo A. et al., “Catalyst-free room-temperature self-healing elastomers based on aromatic disulfide metathesis”, 2013, Materials Horizons, vol. 1, p. 237; Martin A. et al. (supra)). Tensile strength tests were performed as for Sample 1.

Samples 3 and 4: mechanical properties data were taken from manufacturer's published data.

As it can be concluded from Table 3, the self-healed polymer of the invention shows higher tensile-strength values than those known in the prior art.

### BIBLIOGRAPHIC REFERENCES

Damien Montarnal, et al., “Silica-Like Malleable Materials from Permanent Organic Networks”, 2011, Science, vol. 334, p. 965;

Martin R. et al., “The processability of a poly(urea-urethane) elastomer reversibly crosslinked with aromatic disulfide bridges”, 2014, Journal of Materials Chemistry A, vol. 2, p. 5710)

Rekondo A. et al., “Catalyst-free room-temperature self-healing elastomers based on aromatic disulfide metathesis”, 2013, Materials Horizons, vol. 1, p. 237-241

E. Delebecq, et al., “On the Versatility of Urethane/Urea Bonds: Reversibility, Blocked Isocyanate, and Non-isocyanate Polyurethane”, Chem. Rev., 2012,v. 113, p. 80-118;

U.S. Pat. No. 3,905,944

1. A self-healing, reprocessable and recyclable crosslinked polymer comprising units of formula (I) and (Ibis) 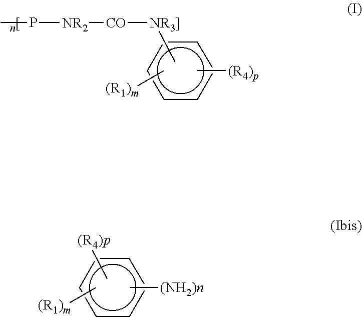
wherein the molar ratio between the units of formula (I) and the units of formula (Ibis) being comprised from 1.0:0.2 to 1.0:0.8; and
wherein
R₄ are radicals independently selected from the group consisting of radicals of formula (II), (III), and (IV): 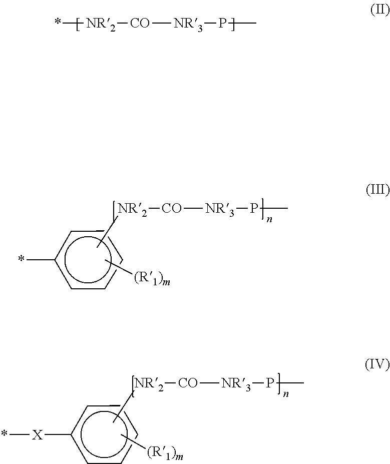
R1 and R1′ are radicals independently selected from the group consisting of: —H, (C1-C20)alkyl, (C5-C14)aryl, —OR5,—(CO)R6, —O(CO)R7, —(SO)R8, —NH—CO—R9, —COOR10, —NR11R12, —NO2, and halogen;
R₂, R_{2′}, R₃, and R_{3′} are —H;
P is a polymeric chain,
*denotes the position through which radical R₄ binds to the phenyl ring of the unit of formula (I),
X is a biradical selected from the group consisting of: —CH₂—, —O—, —NH—, —S—, —CO—, —S(O₂)—, —Si(R₁₃R₁₄)—;
R5 to R12 are radicals independently selected from the group consisting of: —H, (C1-C20)alkyl, and (C5-C14)aryl;
R₁₃ and R₁₄ are radicals independently selected from the group consisting of (C₁-C₅)alkyl, and (C₅-C₁₄)aryl;
(C₅-C₁₄)aryl radical represents a ring system with 1-3 rings which comprises from 5 to 14 carbon atoms, the rings being saturated, partially unsaturated, or aromatic; and being fused, partially fused or isolated; being at least one of the rings an aromatic ring; and the ring system being optionally substituted by one or more radicals independently selected from the group consisting of (C₁-C₆)alkyl, (C₁-C₆)haloalkyl, (C₁-C₆)alkoxy, nitro, cyano, and halogen;
p is from 1 to 2;
m is from 3 to 4; and
n is from 1 to 2; provided that n+m+p is 6;
the polymer comprising from 5 to 25 weight % of urea moieties, and having H-bonding and pi-pi staking interactions between the urea groups, and a tensile strength comprised from 3 to 15 MPa, and
the tensile strength being measured following determined UNE-EN-ISO 527 standard, which comprises the stretching of dumbbell-shaped specimens of normalized dimensions at an elongation rate of 500 mm min^{-1,} and measuring the value of stress (MPa) until the specimen is broken.

2. (canceled)

3. The polymer of any of the previous claim 1, wherein the unit of formula (I) corresponds to a compound of formula (V) 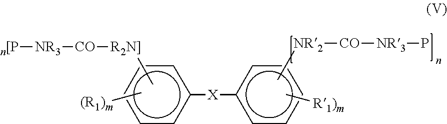
wherein R₁, R₁′, R₂, R₂′, R₃, R₃′, X, m, and n are as defined in claim 1.

4. The polymer of claim 3, wherein the urea birradicals are in para-position relative to the X biradical.

5. The polymer of any of the preceding claim 1, wherein m is 4 and R₁, and R₁′ are —H.

6. The polymer according to any of the preceding claim 1, wherein X is —CH₂—. 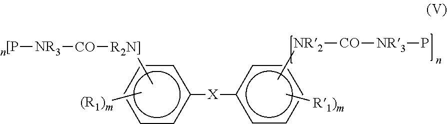
wherein R₁, R₁′, R₂, R₂′, R₃, R ₃′, n and m are as defined in any of the preceding claim 1, and X is —CH₂—.

7. The polymer of any of claim 1, wherein the unit of formula (I) is 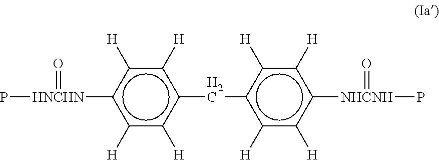
wherein P means a polyurethane polymer.

8. A process for preparing a self-healing, reprocessable, and recyclable polymer as defined in claim 1, comprising the reaction between an isocyanate-functionalised polymer with functionality equal or higher than 2 with an aromatic compound of formula (VI) 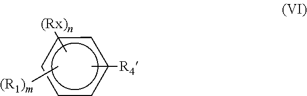
wherein
R₄′ is a radical selected from the group consisting of radicals of formula (VII), (VIII), and (IX) 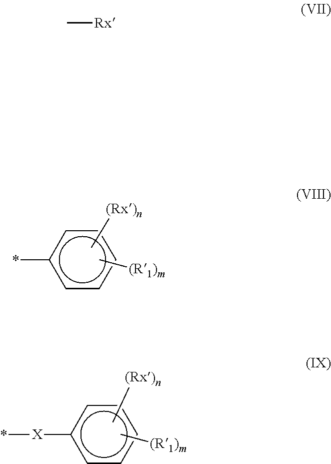
R₁, R₁′, X, m, and n are as defined in claim 1, and
Rₓ and Rₓ′ are —NH₂,
the reaction being performed at a temperature comprised from −30 to 200° C. and wherein the molar ratio between amine and isocyanate groups is from 1.2 to 1.8.

9. The process of claim 8, wherein the isocyanate-functionalised polymer comprises from 2 to 100 isocyanate groups.

10. The process of any of claim 8, wherein the compound of formula (VI) corresponds to one of formula (VIa): 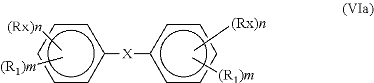
Wherein R₁, R₁′, Rₓ′, m, and n are as defined in claim 8.

11. The process of claim 10, wherein the compound of formula (VIa) is one of formula (VIa′):

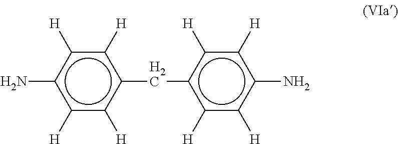

12. A product obtainable by the process according to claim 8.

13. (canceled)

14. A process for recycling a self-healing, reprocessable and recyclable crosslinked polymer comprising units of formula (I) 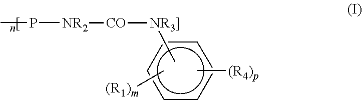
wherein
R₄ are radicals independently selected from the group consisting of radicals of formula (II), (III), and (IV): 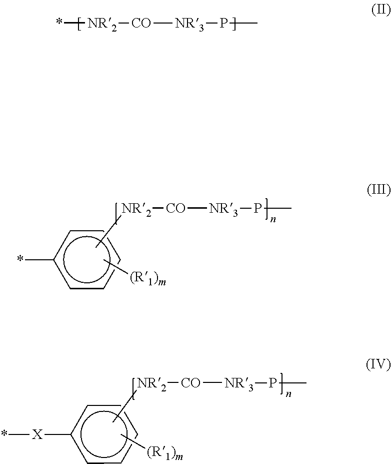
R1 and R1′ are radicals independently selected from the group consisting of: —H, (C1-C20)alkyl, (C5-C14)aryl, —OR5,—(CO)R6, —O(CO)R7, —(SO)R8, —NH—CO—R9, —COOR10, —NR11R12, —NO2, and halogen;
R₂, R₂′, R₃, and R₃′ are —H;
P is a polymeric chain,
*denotes the position through which radical R₄ binds to the phenyl ring of the unit of formula (I),
X is a biradical selected from the group consisting of: —CH₂—, —O—, —NH—, —S—, —CO—, —S(O₂)—, —Si(R₁₃R₁₄)—;
R5 to R12 are radicals independently selected from the group consisting of: —H, (C1-C20)alkyl, and (C5-C14)aryl;
R₁₃ and R₁₄ are radicals independently selected from the group consisting of (C₁-C₅)alkyl, and (C₅-C₁₄)aryl;
(C₅-C₁₄)aryl radical represents a ring system with 1-3 rings which comprises from 5 to 14 carbon atoms, the rings being saturated, partially unsaturated, or aromatic; and being fused, partially fused or isolated; being at least one of the rings an aromatic ring; and the ring system being optionally substituted by one or more radicals independently selected from the group consisting of (C₁-C₆)alkyl, (C₁-C₆)haloalkyl, (C₁-C₆)alkoxy, nitro, cyano, and halogen;
m is from 3 to 4;
n is from 1 to 2;
p is from 1 to 2, provided that n+m+p is 6;
the polymer comprising from 5 to 25 weight % of urea moieties, and having H-bonding and pi-pi staking interactions between the urea groups, and a tensile strength comprised from 3 to 15 MPa, and
the tensile strength being measured following determined UNE-EN-ISO 527 standard, which comprises the stretching of dumbbell-shaped specimens of normalized dimensions at an elongation rate of 500 mm min^{-1,} ′ and measuring the value of stress (MPa) until the specimen is broken.
the process comprising the step of applying pressure and heat to the polymer; or alternatively,
a process for recycling a self-healing, reprocessable and recyclable crosslinked polymer comprising units of formula (I) 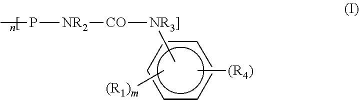
wherein
R₄ are radicals independently selected from the group consisting of radicals of formula (II), (III), and (IV): 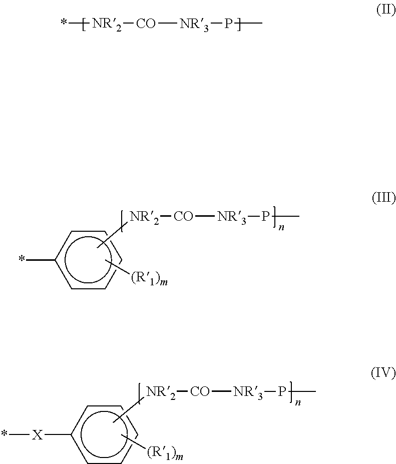
R1 and R1′ are radicals independently selected from the group consisting of: —H, (C1-C20)alkyl, (C5-C14)aryl, —OR5,—(CO)R6, —O(CO)R7, —(SO)R8, —NH—CO-R9, —COOR10, —NR11R12, —NO2, and halogen;
R₂, R₂′, R₃, and R₃′ are —H;
P is a polymeric chain,
*denotes the position through which radical R₄ binds to the phenyl ring of the unit of formula (I),
X is a biradical selected from the group consisting of: —CH₂—, —O—, —NH—, —S—, —CO—, —S(O₂)—, —Si(R₁₃R₁₄)—;
R5 to R12 are radicals independently selected from the group consisting of: —H, (C1-C20)alkyl, and (C5-C14)aryl;
R₁₃ and R₁₄ are radicals independently selected from the group consisting of (C₁-C₅)alkyl, and (C₅-C₁₄)aryl;
(C₅-C₁₄)aryl radical represents a ring system with 1-3 rings which comprises from 5 to 14 carbon atoms, the rings being saturated, partially unsaturated, or aromatic; and being fused, partially fused or isolated; being at least one of the rings an aromatic ring; and the ring system being optionally substituted by one or more radicals independently selected from the group consisting of (C₁-C₆)alkyl, (C₁-C₆)haloalkyl, (C₁-C₆)alkoxy, nitro, cyano, and halogen;
m is from 3 to 4; and
n is from 1 to 2; provided that n+m is 5;
the polymer comprising from 5 to 25 weight % of urea moieties, and having H-bonding and pi-pi staking interactions between the urea groups, and a tensile strength comprised from 3 to 15 MPa, the process comprising the step of applying pressure and heat to the polymer; and
the tensile strength being measured following determined UNE-EN-ISO 527 standard, which comprises the stretching of dumbbell-shaped specimens of normalized dimensions at an elongation rate of 500 mm min^{-1,} ′ and measuring the value of stress (MPa) until the specimen is broken.

15. (canceled)

16. The process of claim 8, wherein the temperature is comprised from 140 to 250° C., and the pressure is comprised from 20 to 100 bars.

17. The process of any one of the claim 14, wherein the polymer comprises units of formula (V) 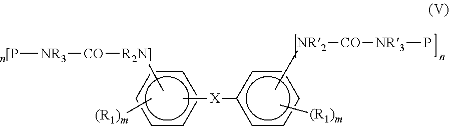
wherein R₁, R₁′, R₂, R₂′, R₃, R₃′, X, m, and n are as defined in claim 14.

18. The process of any claim 14, wherein n is 1.

19. The process of claim 18, wherein the urea birradicals are in para-position relative to the X biradical.

20. (canceled)

21. (canceled)

22. The process of claim 14, wherein the unit of formula (I) is 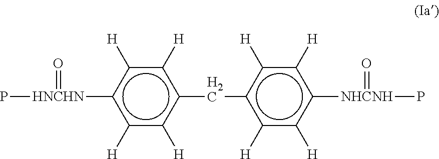
wherein P means a polyurethane polymer.

23. A recycled polymer obtainable by the process as defined in claim 14.

24. An article of manufacture made of the self-healing, reprocessable and recyclable cross-linked polymer according to claim 1.

25. (canceled)
